(19) United States
(12) Patent Application Publication
(10) Pub. No.: US 2025/0045950 A1
(43) Pub. Date: Feb. 6, 2025

(54) MACHINE VISION MARKER, SYSTEM AND METHOD FOR IDENTIFYING AND DETERMINING A POSE OF A TARGET OBJECT USING A MACHINE VISION MARKER, AND METHOD OF MANUFACTURING A MACHINE VISION MARKER

(71) Applicant: MacDonald, Dettwiler and Associates Inc., Brampton (CA)

(72) Inventors: Michel Bondy, Caledon (CA); Piotr Jasiobedzki, Mississauga (CA); Geoff Sprawson, Kleinberg (CA); Steve Fisher, Schomberg (CA); Dragisa Novicic, Kitchener (CA)

(21) Appl. No.: 18/719,871

(22) PCT Filed: Dec. 19, 2022
(86) PCT No.: PCT/CA2022/051860

§ 371 Date: Jun. 14, 2024

Related U.S. Application Data
(60) Provisional application No. 63/290,931, filed on Dec. 17, 2021.

(51) Int. Cl. G06T 7/73; G06K 19/06; G06T 7/13

(52) U.S. Cl. CPC G06T 7/73; G06K 19/06037; G06T 7/13; G06T 2207/20164; G06T 2207/30204

(57) ABSTRACT

Machine vision markers and systems and methods for using and manufacturing machine vision markers are provided. The marker includes a first black target element comprising a black square; a square encoding stripe that extends around a perimeter of and encloses the black square and that is composed of a plurality of square encoding elements collectively encoding a binary data bit sequence encoding identification information about the target object, wherein each respective one of the plurality of square encoding elements is either a black square or a white square representing a data bit of 0 or 1 in the binary data bit sequence, respectively; a white target element comprising a white square ring that extends around a perimeter of and encloses the square encoding stripe; a second black target element comprising a black square ring that extends around a perimeter of the white square ring; and an out of plane white dot post disposed above or below a plane of the marker and positioned centrally on the marker.

### TECHNICAL FIELD

The following relates generally to vision marker systems, and more particularly to visual markers for robotic or autonomous applications and systems and methods for manufacturing and using same.

### INTRODUCTION

Visual targets or markers are used in space proximity operations to help in alignment of mechanical interfaces during, for example, spacecraft rendezvous and docking, satellite capture and berthing, and in robotic servicing of space structures. Distinctive and precisely placed target features facilitate unambiguous and reliable detection, and accurate estimation of relative position and orientation (pose) by the human operators or automatic vision systems. The targets are designed for use by astronauts (direct observations or using camera images) or for automatic detection by vision systems. Existing targets used by vision systems typically do not allow for identification or for multiple targets to be visible in the field of view. The targets are detected in the first image and are tracked in successive frames, which introduce a potential failure condition. Pose estimation using existing targets can be challenging due to either absence of features enabling such pose estimation or to accuracy limitations resulting from location of features on the target.

Accordingly, there is a need for an improved vision marker system, vision marker method, and vision marker that overcome at least some of the disadvantages of existing systems and methods, such as by providing for reliable detection and accurate determination and identification of the relative position and pose (orientation).

### SUMMARY

A machine vision marker for use on a target object is provided. The marker includes: a first black target element comprising a black square; a square encoding stripe that extends around a perimeter of and encloses the black square, the square encoding stripe composed of a plurality of square encoding elements collectively encoding a binary data bit sequence encoding identification information about the target object, wherein each respective one of the plurality of square encoding elements is either a black square or a white square representing a data bit of 0 or 1 in the binary data bit sequence, respectively; a white target element comprising a white square ring that extends around a perimeter of the square encoding stripe and encloses the square encoding stripe; a second black target element comprising a black square ring that extends around a perimeter of the white square ring of the white target element; and an out of plane white dot post disposed above or below a plane of the marker and positioned centrally on the black square of the first black target element.

The square encoding stripe, the white square ring of the white target element, and the black square ring of the second black target element may each have a width equal to a width of one target encoding element.

The marker may further include a black post for raising the out of plane white dot above the plane of the marker, the black post having a base at a first end for mounting the black post to at least one of the target elements and a post tip at a second end opposing the first end on which the out of plane dot is disposed.

The post tip may include a black ring around the out of plane white dot.

Each of the white target element, the white square encoding elements, and the out of plane white dot may be composed of a retroreflective material.

The black square encoding elements may be integrally formed with and arranged around the perimeter of the black square of the first black target element, forming a target pattern element; the white target element may be a white square, and the white square ring of the white target element forms an outer perimeter of the white square; and the target pattern element may be disposed centrally on the white target element such that the white square encoding elements of the square encoding stripe are formed from portions of the white square around the perimeter of the black square of the target pattern element that are not obscured by the black square encoding elements.

The marker of claim 1, further comprising a recess in a visualized side of the marker for lowering the out of plane white dot below the plane of the marker, and wherein the out of plane white dot is disposed in the recess.

The square encoding stripe may include a redundant encoding of the identification information of the target object which allows for correct decoding of the target object identity with up to three bit flips in the binary data bit sequence.

The square encoding stripe may include four corner square encoding elements, and the data bit values of the four corner encoding elements may be predetermined based on fixed corner square encoding element values that are used across all markers of which the marker is one instance.

The four corner square encoding elements may include a top left encoding element, a top right encoding element, a bottom right encoding element, and a bottom left encoding element, and either the top left and top right encoding elements are black squares and the bottom left and bottom right encoding elements are white squares or the top left and top right encoding elements are white squares and the bottom left and bottom right encoding elements are black squares.

The data bit sequence may be encoded clockwise in the square encoding stripe with a first data bit of the data bit sequence encoded in a predetermined one of the four corner target encoding elements.

The first black target element may be at least 10 square encoding elements wide, and each of the square encoding stripe, the white square ring of the white target element, and the black square ring of the second black target element may have a width equal to one square encoding element.

The first black target element may be at least 10 target encoding elements wide and the second black target element may be at least 16 target encoding elements wide.

The out of plane white dot may have a dot diameter equal to a diagonal length of one square encoding element.

The target pattern element, the white target element, and the second black target element may be three separate pieces of material that are assembled to form the marker.

The second black target element may be a square piece of material having a square shaped recess dimensioned to receive the white target element therein and a non-recessed portion extending around the recess which forms the black square ring, and the marker may be assembled by mounting the white target element in the square shaped recess of the second black target element and mounting the first black target element on the white target element.

According to some embodiments, the target pattern element comprises beveled edges.

A system comprising a machine vision marker and a machine vision subsystem is provided. The machine vision marker includes: a first black target element comprising a black square; a square encoding stripe that extends around a perimeter of and encloses the black square, the square encoding stripe composed of a plurality of square encoding elements collectively encoding a binary data bit sequence encoding identification information about the target object, wherein each respective one of the plurality of square encoding elements is either a black square or a white square representing a data bit of 0 or 1 in the binary data bit sequence, respectively; a white target element comprising a white square ring that extends around a perimeter of the square encoding stripe and encloses the square encoding stripe; a second black target element comprising a black square ring that extends around a perimeter of the white square ring of the white target element; and an out of plane white dot post disposed above or below a plane of the marker and positioned centrally on the black square of the first black target element. The machine vision subsystem includes an imaging device for capturing image data of the target and a processing device. The processing device is configured to: detect the square encoding stripe in the image data; decode corner data bit values for each of four corner square encoding elements of the square encoding stripe; determine an orientation of the marker in the image data using the corner data bit values by referencing predetermined corner values for the marker stored in memory; decode the data bit sequence using the determined orientation; determine whether the decoded data bit sequence matches a reference data bit sequence stored in a reference database;

The reference data bit sequence may be linked in the reference database to target object identification data identifying an attribute of the target object, and the processing device may be further configured to use the linked target object identification data in a subsequent processing operation if the decoded data bit sequence matches the reference data bit sequence.

The target object identification data may include a target object ID and the processing device may be configured to identify the target object using the target object ID.

The processing device may be further configured to: detect corners of the white square in the image data of the marker for use as pose calculation features and determine a pose of the target object using the pose calculation features.

In an embodiment, the processing device may detect the corners of the white square using a region based detector, such as maximally stable external region (“MSER”) detector, that finds pixels that belong to bright regions surrounded by dark regions. The processing device may be further configured to then break the contour down into a quadrilateral. The processing device may be further configured to then find sub-pixel equations of the four lines of the quadrilateral. The processing device may be further configured to then intersect the four line equations to find the sub-pixel corners of the white square.

The processing device may be further configured to refine the pose of the target object using the out of plane white dot.

A method of assembling a machine vision marker for use on a target object is provided. The method includes: providing a square black baseplate having top and bottom surfaces, the bottom surface for mounting the baseplate to the target object, the top surface including a square recess centrally positioned on the top surface and a non-recessed portion forming a black square ring around the square recess; disposing a square white plate having top and bottom surfaces in the square recess of the square black baseplate such that the bottom surface contacts a bottom surface of the recess; mounting a black target pattern plate on the top surface of the square white plate, the black target pattern plate comprising an inner square and a plurality of black data bit encoding squares arranged around a perimeter of the inner square, the plurality of black data bit encoding squares collectively composing an encoding region of the black target pattern plate that is one data bit encoding square wide, wherein: the mounting of the black target pattern plate on the top surface of the square white plate forms a square encoding stripe around the perimeter of the inner square of the black target pattern plate, the square encoding stripe including the plurality of black data bit encoding squares of the black target pattern plate and a plurality of white data bit encoding squares formed by square regions of the square white plate not obscured by the encoding region of the black target pattern plate; and the plurality of black data bit encoding squares and the plurality of white data bit encoding squares of the square encoding stripe collectively encode a data bit sequence representing identifying information about the target object; and mounting a post to at least one of the black baseplate, white plate, and the target pattern plate such that the post is positioned centrally on the target, the post including: a black rod having a base for mounting the post to the at least one of the black baseplate, white plate, and the target pattern plate and a tip opposing the base; and a white dot centrally positioned on a top surface of the tip of the rod.

A method of manufacturing a square machine vision marker having improved roll ambiguity properties for determining marker orientation in use is provided. The method includes: manufacturing a plurality of square machine vision markers each having a square encoding stripe comprising a plurality of square encoding elements, each square encoding element being black or white, the square encoding stripe encoding a binary data bit sequence decodable by a machine vision system to obtain information about a target object on which the marker is displayed; wherein the square encoding stripe of each of the plurality of square machine vision markers includes the same predetermined corner square encoding element values such that the corner square encoding element values are fixed and consistent across the plurality of square machine vision markers, the corner square encoding elements being configured such that two non-opposing corner encoding elements are black squares and two non-opposing white corner encoding elements are white squares.

The plurality of square machine vision markers may include at least a first machine vision marker having a first square encoding stripe and a second machine vision marker having a second square encoding stripe, the first and second square encoding stripes being different.

A method of detecting a target pose of a machine vision marker is provided. The method includes determining a target orientation of the machine vision marker, determining a target ID of the machine vision marker, and calculating a target pose of the machine vision marker.

According to some embodiments, the method further comprises determining a target size using the target ID.

According to some embodiments, determining the target orientation comprises sampling corner data bits of the machine vision marker.

According to some embodiments, determining the target ID comprises sampling data bits of the machine vision marker.

According to some embodiments, the method further comprises capturing an image including at least one machine vision marker.

According to some embodiments, the method further comprises performing an unwarping operation on the image to obtain an unwarped image and using the unwarped image to determine the target orientation.

According to some embodiments, the method further comprises performing blob detection on the on the unwarped image prior to determining the target orientation.

According to some embodiments, the blob detection comprises maximally stable external region blob detection.

According to some embodiments, the method further comprises performing blob contour following on a blob detected by the blob detection to obtain a contour corresponding to the exterior of a white element of the machine vision marker.

According to some embodiments, the blob contour following comprises a vertex following algorithm.

According to some embodiments, the method further comprises calculating a convex hull of the blob contour.

According to some embodiments, the method further comprises determining a nearest quadrilateral from the convex hull.

According to some embodiments, the method further comprises calculating a homography of the quadrilateral to determine data bit sampling locations.

According to some embodiments, the method further comprises performing a subpixel line fit on the image to obtain a subpixel transition of the step edge of the white element of the machine vision marker.

According to some embodiments, the method further comprises determining a location of a post tip of the machine vision marker.

According to some embodiments, calculating the target pose of the machine vision marker comprises applying the quadrilateral a post tip location.

According to some embodiments, the target ID is any one or more of a marker ID, a target object ID, and an interface type ID.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a front view of a machine vision marker, showing a side of the machine vision marker that is to be visualized by a machine vision system (“visualized side”), according to an embodiment;

FIG. 2 is a front view of an example of the machine marker of FIG. 1 including an encoding region composed of black and white target encoding elements, according to an embodiment;

FIG. 3 is a schematic diagram of portion of a machine vision marker including an out of plane white dot surrounded by a black ring and raised above or below a plane of the marker, illustrating separation of the out of plane white dot from the projection of the white parts of the marker behind the out of plane white dot, according to an embodiment;

FIG. 4 is a front view of two machine vision markers of the same size including a first machine vision marker having a configuration as described in the present disclosure, according to an embodiment, and a second machine vision marker having a different configuration, illustrating location of pose calculation features on the first and second machine vision markers;

FIG. 5 is a front perspective view of two examples of the machine vision marker of FIG. 1, illustrating features of the markers used to determine pose, according to embodiments;

FIG. 6 is an exploded perspective view of an example of the machine vision target of FIG. 1, according to an embodiment;

FIG. 7 is a flow diagram of a method of assembling the machine vision marker of FIG. 6, according to an embodiment;

FIG. 8 is a perspective view of an example of the machine vision marker of FIG. 6 in assembled form, according to an embodiment;

FIG. 9 is a front perspective view of a plurality of machine vision markers having different encoding regions, according to embodiments;

FIG. 10 is a front view of a large machine vision marker and a small machine vision combined into a dual machine vision marker sharing a single out of plane white dot, according to an embodiment;

FIG. 11 is a block diagram of a system for identifying and determining pose of a target object using the machine vision marker of FIG. 1, according to an embodiment;

FIG. 12 is a flow diagram of a method of detecting and identifying a machine vision marker, such as the marker FIG. 1, and determining a pose of a target object using the machine vision marker, according to an embodiment

FIG. 13 is a schematic diagram of a machine vision marker, such as the marker of FIG. 1, further illustrating the role of various encoding elements (data bits) in the square encoding stripe, according to an embodiment;

FIG. 14 is a schematic diagram of a machine vision marker, such as the marker of FIG. 1, illustrating where sampling points are defined on the marker with respect to the corners of the white square of the marker for initial image processing of a marker image, according to an embodiment.

FIG. 15A is a first perspective view of a machine vision marker having an out of plane white dot that is recessed below the plane of the square encoding stripe, according to an embodiment;

FIG. 15B is a second perspective view of the machine vision marker of FIG. 15A;

FIG. 16 is flow diagram of a method of detecting and identifying a machine vision marker, such as the marker of FIG. 1, and determining a pose of a target object using the machine vision marker, according to an embodiment;

FIG. 17 is a flow diagram of a method of detecting and identifying a machine vision marker, such as the marker FIG. 1, and determining a pose of a target object using the machine vision marker, according to an embodiment;

FIG. 18 is a depiction of image warping, showing an example warped image and unwarped image;

FIG. 19 is a depiction of a contour following algorithm, according to an embodiment;

FIG. 20 is a front view of a machine vision marker, showing the marker with bit sampling locations identified and bit sampling locations not identified, according to an embodiment; and

FIG. 21 is a perspective view and detail perspective view of a machine vision marker and marker variant, demonstrating the function of the chamfered or beveled structure of the marker, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. Computer programs described herein may include or implement machine learning or machine intelligence computer programs, software applications, software modules, models, or the like for the performance of various computing tasks described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to vision marker systems, and more particularly to visual markers for robotic or autonomous applications and systems and methods for manufacturing and using same. The machine vision markers of the present disclosure may be used to identify a target object on which the machine vision marker is disposed and determine a position and orientation (“pose”) of the target object.

The present disclosure provides a new approach to designing and using visual targets and markers for space operations. This approach incorporates both redundant designs and suitable computer vision algorithms that allow reliable detection even with significant data loss in the image. Encoding marker identity allows using the same structure for both object identification and pose determination. In an embodiment, a three dimensional (“3D”) target structure is used to provide more accurate pose estimation. The markers may be detected in every image without reliance on processing previous images (i.e. no tracking).

The design of the machine vision marker of the present disclosure provides for reliable detection, accurate pose determination, and identification in space proximity operations. The machine vision marker of the present disclosure provides precise detection from a wide range of distances and viewing angles. The geometric pattern on the machine vision marker may encode information in data bits, advantageously allowing unique identification of the marker (e.g. a target or marker ID corresponding to the data bits) and solving roll ambiguity due to the four side roll symmetry of a square marker. The data bits can be used by a software application to determine dimensions of a given marker (such as through retrieving marker dimension data using the determined marker ID), indicating how small or big the marker was built. The dimensional information of the marker is used to determine a range of the marker, a bearing of the marker, and a pitch/yaw of the marker.

Further, the redundant design and encoding features on the machine vision marker provides reliable operation, including in events of partial data loss due to shadows, specular reflection, and occlusion. The three-dimensional structure of the machine vision marker, particularly the protruding post from the middle of the machine vision marker can improve accuracy when computing the pose. The method of detecting the machine vision marker as described in the present disclosure may provide detection of markers in every frame without inter-frame tracking, which may advantageously enable instant recovery from occlusion or image loss.

While aspects of the present disclosure describe use of the machine vision marker as a space vision marker (i.e. in a space-based application), it is to be understood that the machine vision marker, as well and the machine vision systems and methods, may also be used in non-space contexts in which machine vision markers are used while providing similar advantages. As such, the use of the machine vision marker of the present disclosure is not limited to space applications.

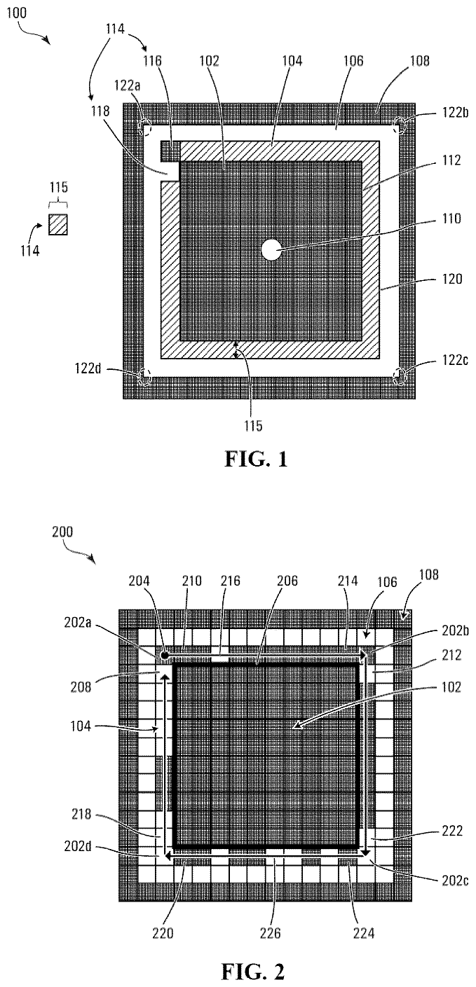

Referring now to FIG. 1, shown therein is a machine vision marker 100, according to an embodiment.

The view shown of the machine vision marker 100 in FIG. 1 illustrates a “visualized side” of the machine vision marker 100; that is, a side of the machine vision marker 100 that is intended for visualization or imaging by a machine vision system.

The machine vision marker 100 (also referred to as “vision marker”, “marker”, “vision target”, or “target”) may be used for detection and identification of an object to which the marker 100 is attached. In an embodiment, the object may be a space object and the vision marker 100 may be used to detect and identify the space object during an operation in space. The operation may be, for example, a capture, docking, or rendezvous operation. Similarly, the vision marker 100 may be attached to an object that is to be used in space, or a replica or emulation thereof, for ground testing of robotic systems interaction using the vision marker 100.

The machine vision marker 100 may be used in a robotic system (space-based or otherwise) for detecting and determining an identity and pose of an object on which the marker 100 is visible to a machine vision system.

For example, a robotic system including a robotic arm or manipulator with an end effector or capture tool may be configured to visualize the marker 100 via a camera system. Outputs of the visualization of the marker 100, such as an identity (identification information) or pose of the target object, may then be used by the robotic system to control the robotic manipulator such that the capture device captures the object. Capture of the object may then enable the object to be manipulated via the robotic manipulator, such as by maneuvering the object from one location to another, actuating the object (e.g. applying torque thereto), or passing data/power to or from the object. In this way, the machine vision marker 100 may provide vital information to the robotic system to enable effective autonomous interaction with the object.

Generally, the machine vision marker 100 includes encoded information and features that enable determination of the identity of the object and the pose of the object to which the vision marker 100 is attached when visualized.

The machine vision marker 100 may be mounted on an external surface of the target object or otherwise positioned on or attached to the target object such that the machine vision marker 100 can be visualized by an external machine vision system.

The machine vision marker 100 includes a first black target element 102, a square encoding stripe 104, a white target element 106, a second black target element 108, and an out of plane white dot 110. In some embodiments, the out of plane white dot 110 may not be present.

The first black target element 102 includes a black square (also referred to as the “inner black square”) defined by a square perimeter 112. In some cases, such as described herein, the first black target element 102 may include more than just the inner black square (e.g. a portion of the first black target element 102 may extend beyond the perimeter but be obscured by other marker components when the marker is in assembled form).

The square encoding stripe 104 extends around the perimeter 112 of the black square of the first black target element 102. For example, the square encoding stripe 104 may abut the perimeter 112 of the black square of the first black target element 102.

The square encoding stripe 104 can be defined generally as the space between the perimeter 112 of the inner black square of the first black target element 102 and an inner square perimeter 120 of a white square ring of the white target element 106 (the white square ring of the white target element 106 is the portion of the white target element 106 visible in FIG. 1).

The square encoding stripe 104 includes a plurality of square shaped target encoding elements 114.

The encoding elements 114 are generally arranged in a side-by-side configuration extending around the length of the square encoding stripe 104 (with one side of each encoding element 114 abutting the perimeter 112 of the black square of the first black target element 102, except in the case of corner encoding elements where a corner of the encoding element abuts a corner of the perimeter 112 of the black square, and a second opposing side abutting the inner perimeter 120 of the white square ring of the white target element 106).

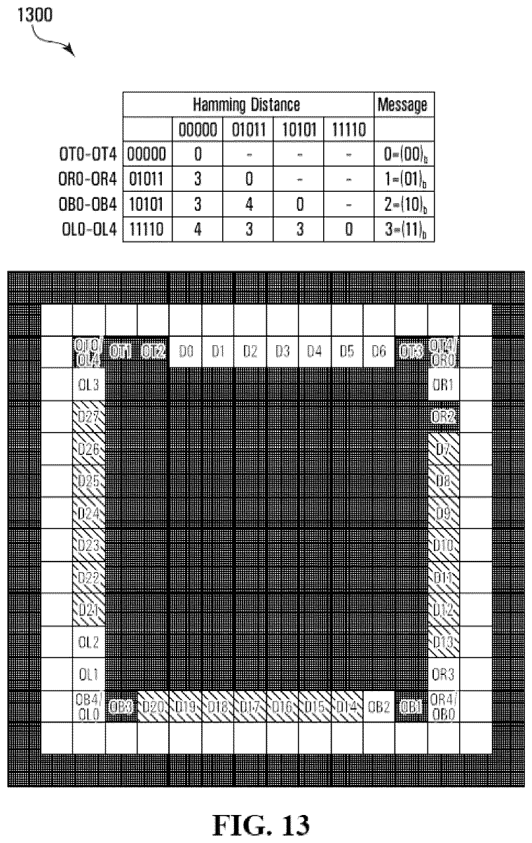

The square encoding stripe 104 has a width 115 of one target encoding element. In other embodiments, the width 115 of the square encoding stripe 104 may vary. In other embodiments, the square encoding stripe 104 may have a width greater than one square ring of data bits (encoding elements) to increase the number of target encoding elements in the marker 100. Such configurations may be used to provide for more markers (i.e. greater number of possible data bit sequences) or greater redundancy (tolerant to a higher number of bit flips). Accordingly, the width of the square encoding stripe 104 can vary and may depend on needs. In a particular embodiment, such as marker 1300 shown in FIG. 13 (in which one square of the grid overlaid the marker equals an encoding element of the encoding region), the marker may provide 8191 unique marker IDs with error correcting of three bit flips using an encoding stripe 104 having a width of one target encoding element.

The plurality of target encoding elements 114 collectively encode a binary data bit sequence. The binary data bit sequence encodes identification information of the object on which the marker 100 is disposed.

The identification information, once decoded, can be used to determine an identity of the target object and/or interface associated with the marker or target ID. Generally speaking, the identification information encoded in the binary data bit sequence can be used to distinguish the target object from other objects. This distinguishing may include distinguishing between classes or types of objects and/or distinguishing between objects within the same class or type. The data bit encoding can be used to “throw away” bright squares in an image that are not markers, so the system does not detect markers that are not there (false positives). This can be done by determining whether the data bit sequence matches a marker ID in a marker ID database. Thus the system incorporates a form of noise rejection where image artifacts that resemble target geometries can be rejected before processing.

It can be understood that by changing the pattern of target encoding elements 114 in the square encoding stripe 104 (i.e. which encoding elements are black and which are white), different information can be encoded in the square encoding stripe 104. As such, the square encoding stripe 104 can be varied across different instances of the marker 100 to encode identification information corresponding to different target objects to enable their identification (and differentiation from other objects).

Each target encoding element 114 is either a black square or a white square. A black square encoding element encodes or represents a data bit of 0 in the binary data bit sequence encoded in the square encoding stripe 104. A white square encoding element encodes or represents a data bit of 1 in the data bit sequence encoded in the square encoding stripe 104. The use of black and white encoding elements may enable intensity values of the encoding elements to be determined via suitable computer vision technique and the intensity values used to determine the encoded data bit sequence.

FIG. 1 shows a representative black square target encoding element 116 of the square encoding stripe 104 and a representative white square target encoding element 118. The remainder of the square encoding stripe 104 in FIG. 1 has been shaded grey. The grey shading of the square encoding stripe 104 is intended to represent that, depending on the encoding of a particular target 100, individual target encoding elements 114 in the square encoding stripe 104 may be black or white. As such, in an actual implementation of the marker 100, the square encoding stripe 104 would be filled with some combination of black and white squares 116, 118.

A particular example of a vision marker 100 with a complete encoding region is shown in FIG. 2, which illustrates an example 200 of the machine vision marker 100 of FIG. 1 in which the square encoding stripe 104 is composed of black and white encoding elements representing a particular data bit sequence.

The example marker 200 is shown as including gridlines. The gridlines are included for illustrative purposes. It is to be understood that gridlines may not be present in the actual marker 200.

In the example 200 of FIG. 2, the square encoding stripe 104 encodes a binary data bit pattern of 00010000000010000000011010110010011100011111. The square encoding stripe 104 may include data encoded with a redundant encoding. The redundant encoding may allow for recovery (i.e. ability to still decoded the correct target ID) from up to 3 bit flips. Such bit flips may be caused, for example, by occlusion, noise or unfavorable illumination. Redundant encoding is achieved using an encoding redundancy scheme. In an embodiment, redundant encoding may be achieved using BCH encoding that adds a prefix to the actual message. For example, there may be a total of 2\hat{ }13 messages encoded in a 27 bit code. Each code is different to every other code by at least seven bits. That means any code can be different by up to three data bits from the true code and still be ‘nearest’ to the correct code (i.e. the scheme can handle three bit flips and still arrive at the correct code). As soon as the code is different by four bits or more, that code is actually closer to another code than the correct one.

In some cases, ‘middle’ data bits in the data bit sequence (the middle data bits being those data bits that are not predetermined corner data bits, as described herein) may be decoded to obtain a marker ID for the marker 200.

A top left corner encoding element 202a (that is, top left in the view shown in FIG. 2) of the square encoding stripe 104 represents a starting point 204 of the data bit pattern encoded by the square encoding stripe 104.

The starting point 204 is the first data bit in the data bit sequence. The data bit sequence is encoded in the square encoding stripe 104 in a clockwise manner, as illustrated by arrows in FIG. 2, starting from the top left corner encoding element 202a.

The data bit sequence proceeds from the top left corner encoding element 202a, to a top right corner encoding element 202b, to a bottom right corner encoding element 202c, to a bottom left corner encoding element 202d, and then to an encoding element immediately preceding the top left corner encoding element 202a.

Corner encoding elements 202a, 202b, 202c, 202d are referred to collectively herein as corner encoding elements 202 and generically as corner encoding element 202.

In variations, the data bit sequence may be encoded in the square encoding stripe 104 in any predetermined order from which the data bit sequence can be retrieved from the square encoding stripe 104. For example, in another embodiment, the data bit sequence may be encoded in a counterclockwise manner from the starting point 204.

In other embodiments, the starting point 204 may vary in its position in the square encoding stripe 104 such that another encoding element is the first encoding element in the data bit sequence encoded in the square encoding stripe 104. For example, the starting point 204 may be any of corners 202b, 202c, or 202d.

In an embodiment, the marker 100 design and decoding software may be configured to first determine which corner of the square encoding region 104 is the upper left corner. To make such a determination, the marker 100 orientation must be known. The marker orientation determination is solved with the corner bits of the square encoding stripe 104. Once the marker orientation is determined (using the corner bits), the decoding software is further configured to determine the marker ID by starting the data bit stream at the correct corner (i.e. upper left corner, in this case). Without solving the roll ambiguity, starting at another corner of the square encoding region 104 would obtain a different (wrong) marker ID. The order, and direction, and which bits mean what, is completely dependent on the marker design and decoding software. In other embodiments, the marker design and decoding software may be configured to implement a different protocol for selecting the starting square of the square encoding stripe 104 or readout direction of the square encoding stripe 104 once the starting square is identified (i.e. using a different starting square and/or different readout direction).

As described in reference to FIG. 1, it can be seen in marker 200 of FIG. 2 that the square encoding stripe 104 is positioned between the inner black square (the outer perimeter of which is denoted by line 206) of the first black target element 102 and an inner perimeter of the white square ring of the white target element 106.

The square encoding stripe 104 also includes predetermined corner values. The term “predetermined corner value” refers to the fact that the value of each corner encoding element 202a, 202b, 202c, 202d (i.e. whether that corner element 202 is black or white) is predetermined and known, and consistent across instances of the marker 200. For example, a collection of markers 200 may all be manufactured with the same predetermined corner values. Put another way, predetermined corner values include those encoding elements (and corresponding data bits) that are either at or near the corners of the square encoding stripe 104 and that are used to determine marker orientation (4× roll ambiguity), and which are consistent across all instances of a marker. In contrast, ‘middle’ data bits or ‘middle’ encoding elements, include those encoding elements (and corresponding data bits) that are between predetermined corner encoding elements and which may be used to encode information that can be used to determine a marker ID.

The predetermined corner values function as marker orientation features. That is, the predetermined corner values, being known, can be used to determine an orientation of the marker 200 (e.g. which way is up), and more specifically of the square encoding stripe 104, in the target marker image. By enabling the determination of the orientation of the square encoding stripe 104, the starting point 204 of the data bit sequence can be properly identified and the data bit sequence correctly decoded.

In functioning as marker orientation features, the predetermined corner values of the square encoding stripe 104 may advantageously be used to solve the 4× roll ambiguity of a square target such as target 100.

The predetermined corner values may also provide the advantage of enabling orientation of the target marker 100 to be determined both by machine vision techniques and by human observation.

The predetermined corner values are configured such that two of the corner encoding elements 202 are white (data bit value of 1, 202c, 202d) and two of the corner encoding elements are black (data bit value of 0, 202a, 202b), with the two black corner encoding elements (202a, 202b) being in adjacent corners such that each black corner encoding element has one adjacent black corner encoding element and one adjacent white corner encoding element (i.e. the black corner encoding elements are not in opposing corners of the square encoding stripe 104). For example, corner encoding element 202a has one adjacent corner encoding element that is black (element 202b) and one adjacent corner encoding element that is white (element 202d).

In variations, the predetermined corner values may include the top corner encoding elements 202a, 202b having the same value (e.g. black, 0; or white, 1) and the bottom corner encoding elements 202c, 202d having the same value (e.g. white, 1; or black, 0), with the top corner element values and the bottom corner element values being different (e.g. top, black, 0; bottom, white, 1).

In an embodiment, the predetermined corner values include the top left and top right corner encoding elements 202a, 202b each having a value of 0 (i.e. black square) and the bottom left and bottom right encoding elements 202d, 202c each having a value of 1 (i.e. white square).

In a particular embodiment, the predetermined corner values may include additional predetermined values other than just the corners. In particular, the predetermined corner values may include additional predetermined values in encoding elements adjacent to the corner encoding elements 202 in the square encoding stripe 104 (i.e. those encoding elements directly beside the corner encoding element 202 in the encoding stripe 104).

For example, in an embodiment, the adjacent black corner encoding elements (202a, 202b) each have an adjacent black encoding element and an adjacent white encoding element (i.e. each black corner element is flanked by a black element on one side and a white element on the other side) and the adjacent white corner encoding elements (202c, 202d) each have an adjacent white encoding element and an adjacent black encoding element (i.e. each white corner element is flanked by a white element on one side and a black element on the other side).

For the black corner encoding elements, the respective adjacent black encoding elements of the two black corner encoding elements are located on the same side of the square encoding stripe 104 (with the adjacent white encoding elements being located on opposing sides of the square encoding stripe).

For the white corner encoding elements, the respective adjacent black elements of the white corner encoding elements are located on the same side of the square encoding stripe 104 (with the adjacent white encoding elements being located on opposing sides of the square encoding stripe).

In addition to orientation determination and solving roll ambiguity, such configuration of the corner encoding element values and the adjacent encoding element values may advantageously improve manufacturability of the marker 100 in embodiments of the marker 100 in which the black encoding elements of the square encoding stripe 104 are part of the first black target element 102 (i.e. by being integrally formed with the inner black square). This is because such a configuration ensures each black corner encoding element has at least one adjacent black encoding element to support attachment of the black corner element to the inner black square (if there was no adjacent black element, such as if both elements adjacent to the black corner were white, the only point of contact between the black corner element and the inner black square would be the respective corner points of the black corner element the inner black square).

An example of such a configuration is present in marker 200 of FIG. 2. The black corner encoding elements include top left encoding element 202a and top right encoding element 202b. The white corner encoding elements include bottom left encoding element 202d and bottom right encoding element 202c. Black corner encoding elements 202a, 202b are in adjacent corners (i.e. not opposing corners). Top left corner encoding element 202a has an adjacent white encoding element 208 and an adjacent black encoding element 210. Top right corner encoding element 202b has an adjacent white encoding element 212 and an adjacent black encoding element 214. The adjacent black encoding elements 210, 214 of the top left and top right corner elements 202a, 202b are located on the same side 216 of the square encoding stripe 104. Bottom left corner encoding element 202d has an adjacent white encoding element 218 and an adjacent black encoding element 220. Bottom right corner encoding element 202c has an adjacent white encoding element 222 and an adjacent black encoding element 224. The adjacent black encoding elements 220, 224 of the bottom left and right corner encoding elements 202d, 202c are on the same side 226 of the square encoding stripe 104.

Referring again to FIG. 1, the white target element 106 includes a white square ring. The white square ring is visible in FIG. 1, surrounding the square encoding stripe 104. The white square ring may be composed of a retroreflective material. The white square ring surrounds the square encoding stripe 104. In this sense, the white square ring is disposed on the outside of the encoding elements which encode the data bit sequence.

The second black target element 108 includes a black square ring. The second black target element 108 is composed of a black material. The black square ring of the second black target element 108 surrounds the white square ring of the white target element 106.

The white target element 106 and second black target element 108 may each include additional white material and black material, respectively, beyond the respective square rings. For example, a portion of the white target element 106 may be obscured by other elements of the marker 100, such as the square encoding stripe 104 or the inner black square, such that only the white square stripe is visible. Similarly, a portion of the second black target element 108 may be obscured by other elements of the marker 100, such as the white target element 106, the square encoding stripe 104, and the inner black square. Such obscuring of portions of the white and black target elements 106, 108 may occur, for example, when components of the target 100 are placed on top of one another when assembling the target 100.

The out of plane white dot 110 may be raised or recessed relative to a plane of the marker 100. For example, a concave version of the marker 100 may be used in situations where protruding posts are not desirable. The plane of the marker 100 is formed by the visualized surfaces (i.e. those surfaces shown in FIG. 1) of the target elements 102, 106, 108 and encoding stripe 104. The marker 100 may include any suitable structure for raising the out of plane white dot 110 above the plane of the marker 100 or lowering the out of plane white dot 110 below the plane of the target 100. Example of such structures are provided herein. Having the white dot 110 “out of plane” from the rest of the marker 100 can provide superior pitch/yaw accuracy.

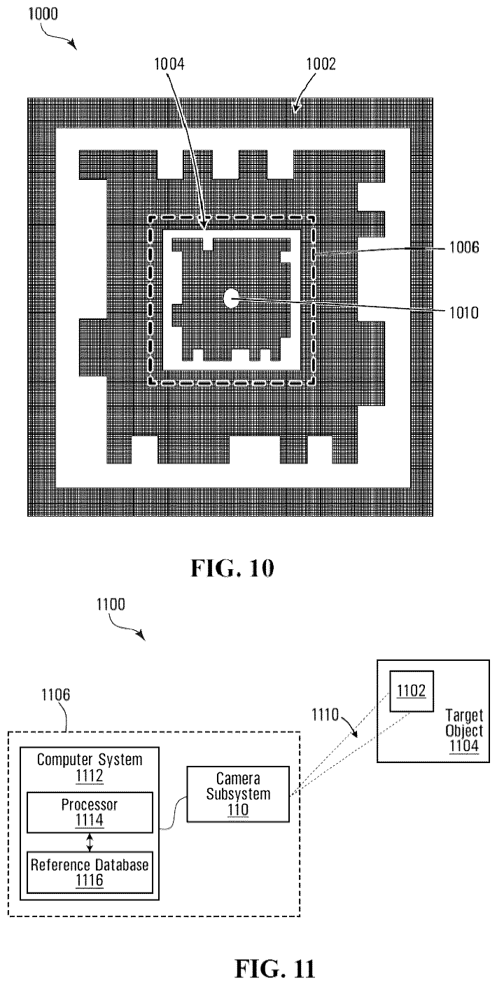

The out of plane white dot 110 of marker 100 is centrally positioned on the marker 100. In other embodiments, the out of plane white dot 110 may be positioned elsewhere on the visualized surface of the marker 100. For example, in a dual marker embodiment including two markers 100 of different sizes combined into a single marker (e.g. FIG. 10), the larger marker may include an out of plane white dot 110 and the out of plane white dot 110 may be positioned outside of a smaller marker which is positioned centrally on the larger marker.

In embodiments where the out of plane white dot 110 is raised relative to the plane of the marker 100, the white dot 110 may be disposed on the end of a black post.

Raising (or recessing) the white dot 110 above (or below) the plane of the target 100, thus making the white dot 100 “out of plane”, may advantageously reduce the error in the pose calculation. This may be especially true in target pitch and yaw.

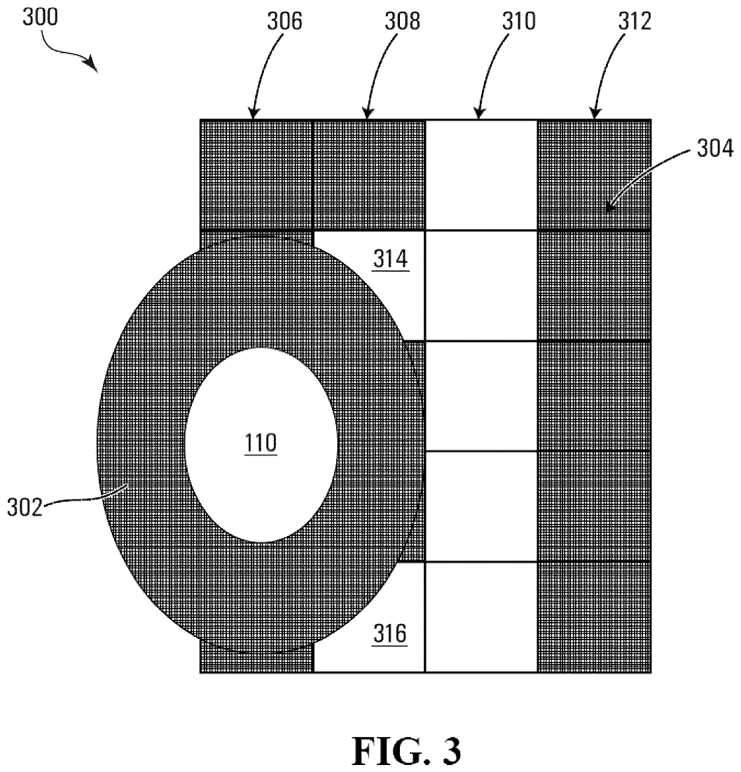

The out of plane white dot 110 may include a black ring around the perimeter of the white dot 110. The black ring separates the white dot from the projection of the white parts of the target (i.e. white square ring, white encoding elements) behind the white dot. This feature is illustrated in FIG. 3. Preferably, the black ring around the white dot is wide enough to separate (i.e. have a few pixels between) the projection of the white dot 110 and the white square behind it. In an embodiment, the width of the black ring may be set to ½ of a data bit width. Preferably, the diameter of the white dot 110 is equal to the diagonal of a data bit (or sqrt(2)*data bit size).

Referring now to FIG. 3, shown therein is a representation 300 of an out of plane white dot 110 with a surrounding black ring 302 and a portion 304 of a target marker, including inner black square 306, square encoding stripe 308, white square ring 310, and black square ring 312, according to an embodiment.

The portion 304 of the target marker may be a portion of marker 100, with components 306, 308, 310, and 312 corresponding to components 102, 104, 106, 108 of FIG. 1.

As can be seen, the black ring 302 surrounding the out of plane white dot 110 separates the white dot 110 from the projection of the white parts of the target 304, such as encoding elements 314, 316 of the square encoding stripe 308.

Referring again to FIG. 1, the marker 100 regions 122a, 122b, 122c, and 122d. Regions 122a, 122b, 122c, and 122d are referred to collectively herein as regions 122 and generically as region 122.

The regions 122 are defined generally as where the outer corners of the white square ring of the white target element 106 meet the inner corners of the black square ring of the second black target element 108.

The regions 122 are points defined by the intersections of the straight lines caused by the step in intensity between the white square ring 106 inside the marker 100 and the black outer square ring 108 (black border) of the marker 100. The corners (vertices) are good features to use because their location can be determined in the 2D image and in the 3D model. Knowing the 2D image location and the 3D model location, the pose of the marker 100 in the camera frame can be determined. Adding the fifth pose calculation feature of the out-of-plane white dot 110 can further improve the accuracy of the calculated pose. In an embodiment, the 2D position of regions 122 may be calculated by fitting straight line equations to the step in pixel intensity on all four sides of the white square ring 106 of the marker with sub-pixel resolution. The line equations are intersected to accurately obtain the corner points to sub-pixel resolution. The pose accuracy at a given camera to marker distance depends on the separation distance between the regions 122. Having the regions 122 on the outside of the data bit square ring 104 (as opposed to having the regions 122 inside the data bit square ring) increases the distance between the 122 regions, which can provide an increase in pose accuracy.

The regions 122 can be used as pose calculation features. That is, when processing an image of the target marker 100 by a machine vision system, the regions 122 can be readily detected by a computer vision algorithm executed by the machine vision system and processed by a pose determination algorithm executed by the machine vision system to determine a pose of the marker 100.

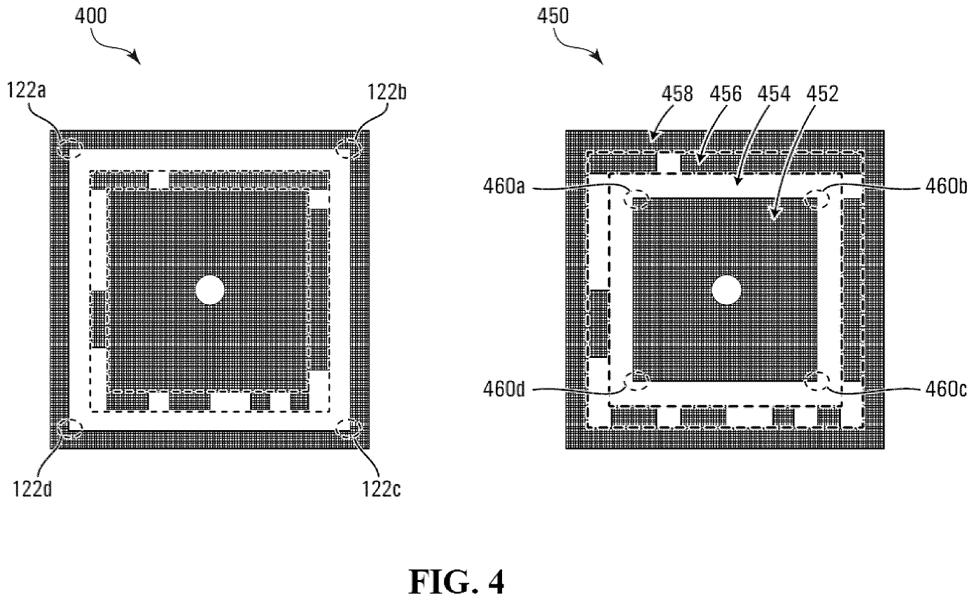

The positioning of the regions 122 on the marker 100 may provide particular advantages in calculating a pose of the marker 100 over other vision marker configurations. Such advantages are illustrated in FIG. 4.

Referring now to FIG. 4, shown therein is a comparison of pose calculation features on a first vison marker 400 having a configuration as described in the present disclosure, according to an embodiment, and a second vision marker 450 having a different configuration. First and second vision markers 400, 450 are the same size.

First vision marker 400 is an example of vision marker 100 of FIG. 1 and includes regions 122a, 122b, 122c, 122d (pose calculation features) which can be used to determine a pose of the marker 100.

On marker 400, the white square ring of the white target element 106 is on the outside of the square encoding stripe 104.

Marker 450 is constructed similarly to marker 400, with a few important differences. Marker 450 includes an inner black square 452, a white square ring 454, an encoding region 456, and an outer black square ring 458.

Marker 450 also includes regions 460a, 460b, 460c, 460d, which can be used to calculate a pose of the marker 450.

On marker 450, the white square ring 454 is disposed on the inside of the encoding region 456 (i.e. the encoding region 456 is on the outside of the white square ring 454).

Advantageously, on marker 400 the regions 122a, 122b, 122c, 122d used to calculate the pose are further apart than the regions 460a, 460b, 460c, 460d on marker 400. In other words, the regions 122 on marker 400 are further apart for a target of the same size.

By increasing the distance between regions 122 on the marker 400 as compared to regions 460 on marker 450 (or other similar target configuration in which features used to calculate pose are not as close to the outer edge of the marker), pose measurement error can be reduced.

Accordingly, the marker of the present disclosure, having the white square ring of the white target element 106 positioned outside the data bit encoding region (square encoding stripe 104) and between the outer black square ring of the second black target element 108 and the encoding region 104 may advantageously improve pose calculation by reducing pose measurement error by increasing distance between pose calculation regions 122 of the marker 100.

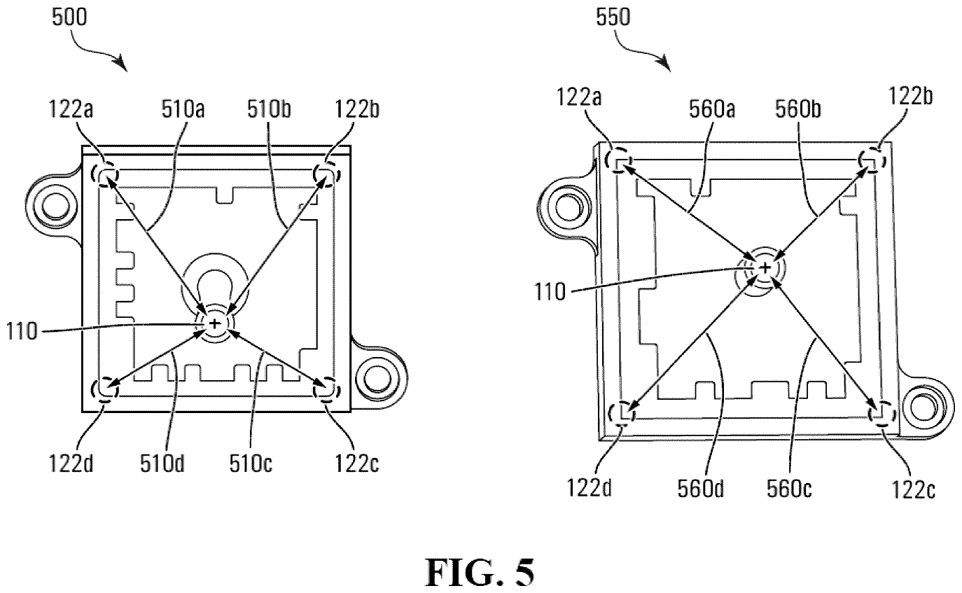

Referring now to FIG. 5, shown therein are first and second example vision markers 500, 550, according to embodiments.

Vision markers 500 and 550 are examples of an embodiment of vision marker 100 including a black target rod centrally mounted on the marker 100 with the out of plane white dot 110 (e.g. white retroreflector disc) mounted to a tip of the black target rod. The black target rod, and thus the out of plane white dot 110, is raised above the plane of the marker 500, 550.

Regions 122a, 122b, 122c, 122d of the markers 500, 550 used for calculating pose are labelled.

Pose determination for the markers 500, 550 can be performed by computing an initial pose using the pose calculation features 122a, 122b, 122c, 122d and then refining the initial pose computation using location of the out of plane white dot 110.

For example, distance of each of the pose calculation features 122a, 122b, 122c, 122d from the center of the out of plane white dot 110 can be calculated and compared/analyzed by the machine vision system processing images of the marker 500, 550 to provide further information on the pose of the marker 500, 550. This is because, as the pose of the marker 500, 550 changes, the distances from the pose calculation features 122 to the out of plane white dot 110 change. Examples of such distances, and how they can vary based on pose, are shown in FIG. 5 as distances 510a, 510b, 510c, 510d on marker 500 and distances 560a, 560b, 560c, 560d on marker 550. As can be seen from distances 510a-510d as compared to distances 560a-560d, markers 500 and 550 have different poses in FIG. 5.

Accordingly, the inclusion in the markers 500, 550 of the out of plane white dot 110 raised above the plane of the marker may advantageously reduce error in pose calculation of the marker 500, 550. This may be particularly true in target marker pitch and yaw.

The pose of the marker 100 is calculated using vision software (e.g. executed by a processor, such as processor 1114 of FIG. 11). The pose of the object on which the marker 100 is mounted can be inferred knowing the rigid transform from the marker origin frame to the reference frame of the object of interest (e.g. grapple fixture that you want to capture, or a tool you want to grasp). So, in the process of integrating a marker 100 and grapple fixture onto a spacecraft, for example, the transformation vectors between the target reference frame and the grapple fixture reference frame may be measured, and also between the grapple fixture reference from and the captured object's frame of reference (sometimes its centre of mass, for example). Further, a reference measurement between the camera imager, and the camera housing frame of reference (sometimes it's mounting bolt location, for example) may be performed, and between the camera housing frame of reference and the capture frame of reference of the end effector may be performed. These reference frame transformations are well understood to be necessary for robotic grapple operations and will be clear to those skilled in the art.

Referring again to FIG. 1, in some embodiments, the square encoding stripe 104 may be a component separate from the white target element 106 and the first black target element 102. That is, the square encoding stripe 104, white target element 106, and first black target element 102 are physically separate components that can be assembled together in the marker 100 such that the square encoding stripe 104 is disposed between the white square ring of the white target element 106 and the inner black square of the first black target element 104.

In other embodiments, the square encoding stripe 104 is constructed from the white target element 106 and the first black target element 102, such that the white square encoding elements 118 of the square encoding stripe 104 are provided by the white target element 106 and the black square encoding elements 116 of the square encoding stripe 104 are provided by the first black target element 104.

For example, the white square encoding elements 118 may be part of the white target element 106 and the black square encoding elements 166 may be part of the first black target element 102, and the square encoding stripe 104 is formed by the positioning of the white target element 104 and the first black target element 102 relative to one another. For example, the white target element 106 may be a square piece of white material which includes the square stripe visible in FIG. 1 at its outer perimeter, and the first black target element 102, which includes the black square encoding elements 116 around perimeter 112, may be disposed on top of the white target element 106 such that portions of the white target element 106 occupying the square encoding stripe 104 are obscured by the black square encoding elements 116 of the first black target element 102 and unobscured portions of the white target element 106 in the square encoding stripe 104 form white square encoding elements 118 of the square encoding stripe 104.

In a particular embodiment, the black square encoding elements 116 are arranged around the perimeter 112 of the inner black square of the first black target element 102 such that the inner black square and any black square encoding elements 118 form a continuous piece of material. In such an embodiment, the white target element 104 may include additional white material beyond what is visible in FIG. 1 (i.e. white square ring) which extends into the square encoding stripe 104. In an embodiment, the first black target element 102 including the black square encoding elements 116 may be mounted on top of the white target element 106 such that portions of the white target element 106 are obscured in the square encoding stripe 104 by the black square encoding elements 116 and portions are unobscured. The unobscured portions of the white target element 106 present in the square encoding stripe 104 form white square encoding elements 118.

White components of the marker 100, such as white target encoding element 106, any white target encoding elements 116 in the square encoding stripe 104, and the out of plane white dot 110 may be composed of a retroreflective material. For example white pigment in such white components may be configured to illuminate when a monochromatic light beam is incident on the marker 100. The marker 100 may be manufactured using surface finishes that provide high contrast and diffuse reflective properties. Such marker 100 can be used under any illumination that produces images adequate for processing. In cases where the marker 100 includes white parts composed of retroreflective material, the retroreflective material may reflect light towards an illuminating light source for a wide range of surface orientations. In such a case, a system for imaging the marker 100 may include a monochromatic light source (e.g. LED light) located close to the camera and a camera lens equipped with a band pass filter that transmits the source light and attenuates any other illumination. In an embodiment, a filter on the lens of the camera may be tuned to the LED wavelength of a camera mounted monochromatic LED to get very bright white.

Black components of the marker 100, such as the black square of the first black target element 102, the second black target element 108, and any black target encoding elements 118 in the square encoding stripe 104 may be composed of a light absorbent material to prevent scattering or reflection of an incident light source on the marker 100. The black components of the marker 100 may be composed of a material to provide sufficient contrast with the white parts of the marker 100. The black material should be sufficiently dark, preferably black in the optical band of interest, and may be matte to avoid any specularity issues from the very intense and constantly changing lighting, such as are present in space operations.

In an embodiment, each of the square encoding stripe 104, the white square ring of the white target element 106, and the black square ring of the second black target element 108 have a width equal to the width of one target encoding element 114.

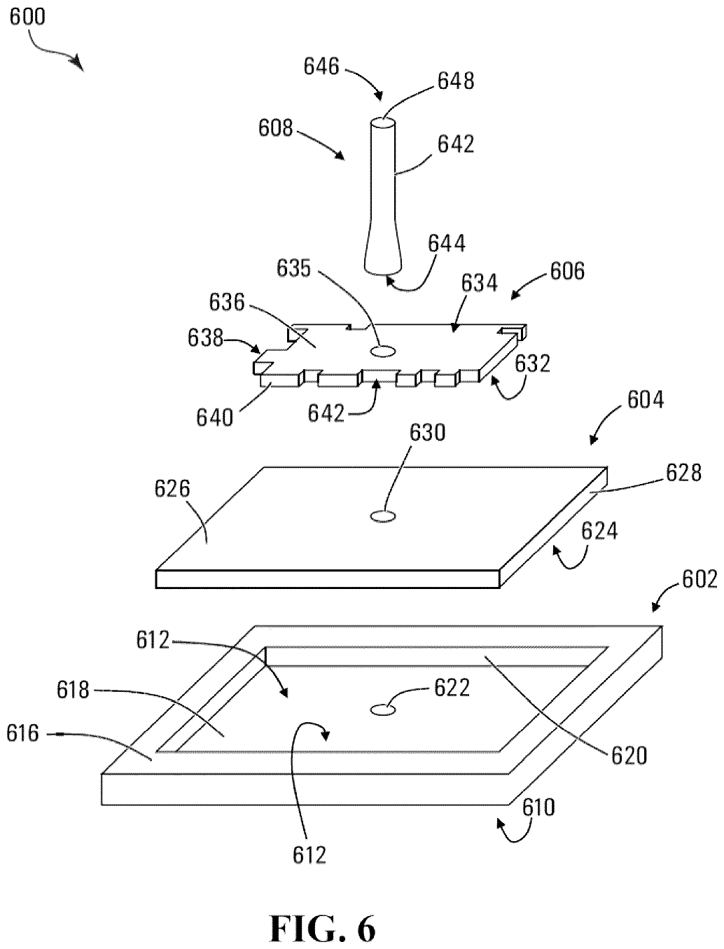

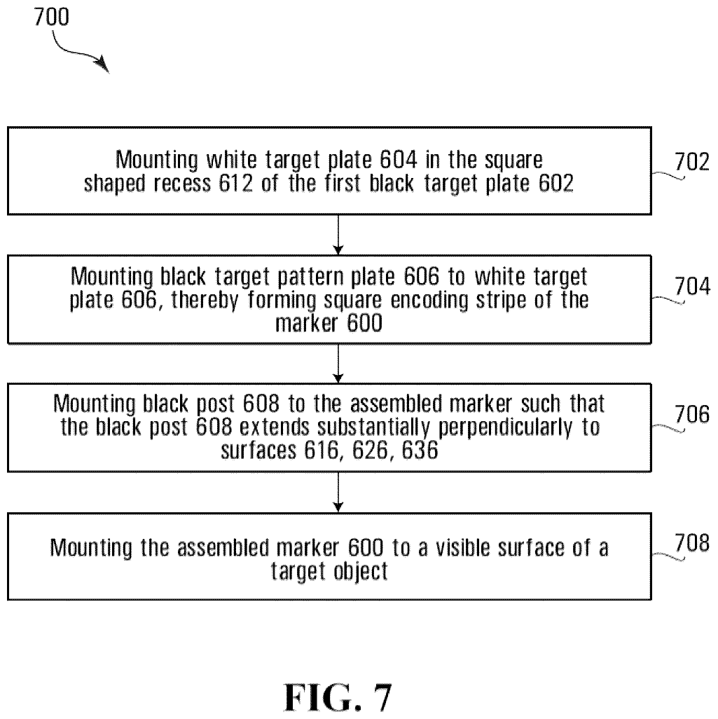

Referring now to FIGS. 6 and 7, shown therein are a machine vision marker 600 and a method 700 of assembling the machine vision marker 600, according to an embodiment.

Referring first to FIG. 6, shown therein is the machine vision marker 600 in exploded view. The machine vision marker 600 is an embodiment of the marker 100 of FIG. 1. Accordingly, any of the examples below may be applied to marker 100 and any examples described above in reference to marker 100 may be applied to marker 600.

The marker 600 includes a first black target plate 602, a white target plate 604, a black target pattern plate 606, and a black post 608.

The first black target plate 602 corresponds to the second black target element 108 of FIG. 1, the white target plate 604 corresponds to the white target element 106 of FIG. 1, and the black target pattern plate 606 corresponds to the first black target element 102 of FIG. 1. The square encoding stripe 104 of the marker 600 is formed by the black target pattern plate 606 and the white target plate 604 when assembled.

The first black target plate 602 has a first surface 610 for mounting the first black target plate 602 (and, when assembled, the marker 100) to a surface of a target object (not shown) and a second surface 612 opposing the first surface 610.

The second surface 612 includes a square shaped recess 614 and a non-recessed outer square ring 616. The square shaped recess 614 is dimensioned to receive the white target plate 604.

The square recess 614 is defined by a bottom surface 618 and four side surfaces 620. The bottom surface 618 includes a circular opening/aperture 622 for receiving at least a portion of the black post 608 therethrough when the marker 600 is assembled.

The white target plate 604 is square shaped and includes a first surface 624, a second surface 626 opposing the first surface 624, and four side surfaces 628. The second surface 626 is composed of a white retroreflective material.

The first surface 624 is used to mount the white target plate 604 in the recess 612 of the first black target plate 602, and in particular to the bottom surface 618 of the recess 612.

The white target plate 604 also includes a circular opening/aperture 630 traversing from the first surface 624 to the second surface 626 for receiving at least a portion of the black post 608 therethrough when the marker 600 is assembled.

The black target pattern plate 606 includes a first surface 632 and a second surface 634 opposing the first surface 632. The first surface 632 is used to mount the black target pattern plate 606 to the second surface 626 of the white target plate 604 in the assembled marker 600.

The black target pattern plate 606 includes a circular opening/aperture 635 traversing from the first surface 632 to the second surface 634 for receiving at least a portion of the black post 608 therethrough when the marker 600 is assembled.

The black target pattern plate 606 includes an inner square portion 636 and an outer target pattern portion 638. The outer target pattern portion 638 is composed of a plurality of black square encoding elements (which correspond to black encoding elements 116 of FIG. 1) arranged about and extending outwardly from an outer perimeter of the inner square 636. The combination of outward projections 640 (which may include one black square encoding element or multiple consecutive black square encoding elements) and recessed portions 642 (which may be dimensioned to correspond to one white square encoding element or multiple consecutive white square encoding elements) in the outer target pattern portion 638 contribute to the formation of the square encoding stripe 104 of the marker 600 when assembled.

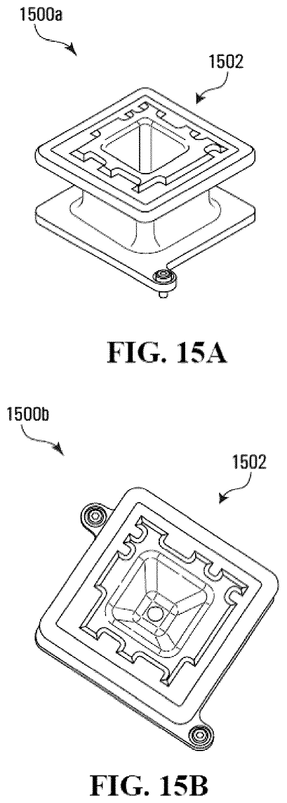

In some examples, the black target pattern plate 606 may include beveled and/or sloped edges. The bevel may be a chamfer. The bevel may be a 45 degree edge. Such sloped edges may improve the readability of the marker 600 and/or the data encoded by the marker, particularly when viewing the marker at severe angles. An example of beveled or sloped edges can be seen in the marker 1502 of FIGS. 15A-15B.

This benefit is further illustrated in FIG. 21, wherein a perspective view 2102 of a marker 2100 having a chamfer and a detail perspective view 2103 of a marker variant 2100B having non-beveled edges is shown, according to embodiments, skewed angles such as shown in point of view 2110), sloped edges of the encoding stripe 2104 prevent the encoding stripe from occluding visibility of the white element 2106 in marker 2100.

In contrast, a non-beveled marker 2100B is shown, wherein the encoding stripe 2104B comprises edges with right angles instead of the beveled edges of marker 2100. These right-angled edges of encoding stripe 2104B occlude the white element 2016B from point of view 2110. Such an occlusion may reduce the ability of a system or operator to decipher the data encoded by encoding stripe 2104B from points of view such as point of view 2110, due to the thickness of the component comprising encoding stripe 2104B. For example, in the example of marker 2100B, from point of view 2110, the data bit may be counted as a 0 (black) where it should be counted as a 1 (white). It may be advantageous to chamfer, bevel and/or slope the edges of the component comprising encoding stripe 2104B (e.g., as shown by stripe 2104) to improve readability or parsability of the marker at severe angles when the encoding stripe 2104 is constructed from a sufficiently thick component or material (e.g., as may be required for structural rigidity).

An example will now be described. A machine vision marker may include a black data bit mask element (or black target pattern plate) that is structural, holding down a retroreflector white target element of the marker. Because of this need for structural rigidity, the thickness of the data bit mask element may need to be increased. One consequence of increasing the data bit mask thickness is that, when viewed on an angle, the black part of the data bit mask element may occlude some of the white reflector, where that part of the reflector should appear white on the camera image. To counter this effect, a chamfer (or other bevel) may be added to the data bit mask element to allow off axis viewing of the target without the black data mask part occluding the white reflector part of the marker. With the chamfer, rays from the camera at more severe angles to a given white data bit (formed by the white reflector) is not occluded. Without the chamfer (e.g., having a data bit mask element with right-angled edges), the same rays may instead hit the top black part of the data bit mask. This may cause the machine vision software to count that data bit as a zero (black) where it should be counted as a 1 (white). Accordingly, the bevel or chamfer provides a marker that can be more accurately viewed at certain imaging angles.

Referring again to FIG. 6, the black post 608 includes a rod 644 having a first end 646 and a second end 648 opposing the first end 646. The first end 646 is used to mount the rod 644 to the rest of the marker 600 (e.g. to the first black target plate 602).

At the second end 648 is a post tip which includes a generally circular retroreflective white disc 648. The white disc 648 corresponds to the out of plane white dot 110 of FIG. 1. The post tip includes a black ring surrounding the white disc 648.

In other embodiments, the post 608 may have a truncated cone shape.

In another embodiment, the post 608 may be replaced with a recess in which the white disc 648 which in effect functions as a “post” with “negative length” (e.g. a recess below the encoding stripe), as described herein.

Referring now to FIG. 7, shown therein is a method 700 of assembling the visual marker 600 of FIG. 6, according to an embodiment.

At 702, the method 700 includes mounting the white target plate 604 in the square shaped recess 612 of the first black target plate 602. This may include, for example, mounting the first surface 624 of the white target plate 604 to the bottom surface 618 of the recess 612 of the first black target element 602. The white target plate 604 may be dimensioned such that when the white target plate 604 is disposed in the recess 612, the second surface 626 of the white target plate 604 is generally level with the outer square ring portion 616 of the second surface 612 of the first black target element 602.

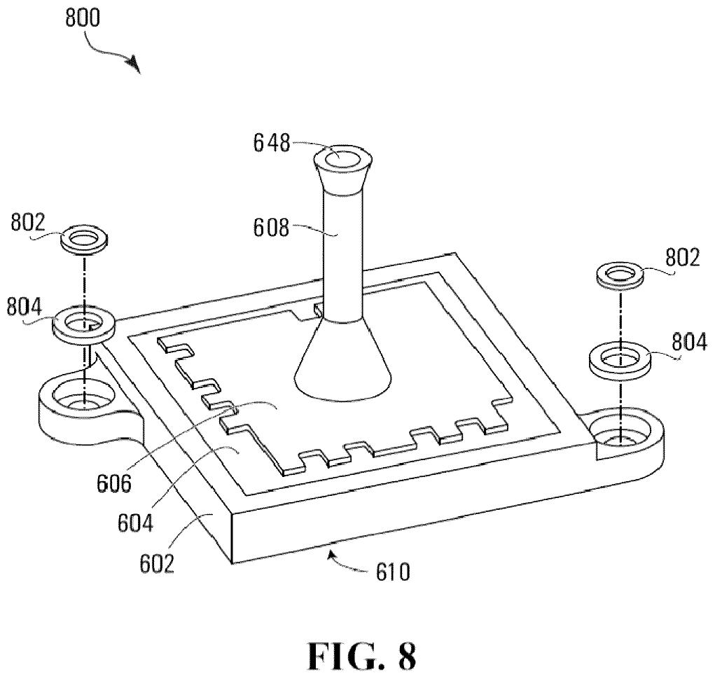

In an embodiment, the white plate 604 is press fit and glued into the bottom black plate 602 and redundantly held down by the data bit pattern plate 606 and post 608. The post 608 may be held down by a bolt that goes through the whole lot up into the post 608. Dowel pins may be used to align the marker 600 with the object to be tracked. The marker 600 may include mounting ‘ears’, visible in the marker 800 of FIG. 8, which are asymmetric versus the dowel pins so the marker 600 can only go onto the object one way. In another embodiment, the white plate 604 may be attached to the first black target plate 602 using a ‘picture frame’ where a black border goes around the white reflector plate 604 to hold the white plate 604 down and to provide the contrasting lines.

At 704, the method 700 includes mounting the black target pattern plate 606 to the white target plate 604. In particular, first surface 632 of the black target pattern plate 606 is mounted centrally on second surface 626 of the white target plate 604. In some cases, centrally mounting the black target pattern plate 606 may include aligning the circular openings 635, 630 of the respective plates.

Upon mounting the black target pattern plate 606 to the white target plate 604, the square encoding stripe 104 of the marker 600 is formed. The square encoding stripe 104 is formed from the rectangular projections of the outer target pattern portion 638 of the black target pattern plate 606, which provide the black square encoding elements, and the rectangular portions of the second surface 626 of the white target plate 604 that fill the rectangular recesses 642 in the outer target pattern portion (i.e. such portions of the white target plate 604 are visible and not obscured by the outer target pattern portion), which provide the white square encoding elements.

The outer perimeter of the square encoding stripe 104 of marker 600 is formed by the outer edge of the rectangular projections 640.

Mounting the black target pattern plate 606 to the white target plate 604 in this manner also forms the white square ring of the white target plate 604, which corresponds to the square ring portion of the second surface 626 of the white target plate 604 that extends around the outside (i.e. surrounds) the square encoding stripe 104 (i.e. the portion of surface 626 lying outside the outer edge of the rectangular projections 640).

At 706, the method 700 includes mounting the black post 608 to the assembled target plates 602, 604, 606. Mounting the black post 608 may including mounting the first end 644 to any one or more of the target plates 602, 604, 606. The black post 608 may be mounted to the marker 600 using a bolt or the like that goes from under the marker 600 (underside 610) through 622, 630, 635, and into the post 608. The bolt holds all the marker 600 components together.

The black post 608 is mounted such that the black post 608 extends substantially perpendicularly to the plane of the assembled target (e.g. perpendicular to each of surfaces 616, 626, 635).

Steps 702-706 form the assembled marker 600. In variations, steps 702-706 may be performed in any order. For example, the target pattern plate 606 may be mounted to the white target plate 604 and then the assembled target pattern plate 606 and white target plate 604 mounted to the black target plate 602. In embodiments where black post 608 is not present, step 706 is not performed and the assembled marker 600 is formed by performing 702 and 704.

At 708, the method 700 further includes mounting the assembled marker 600 formed from steps 702-706 to the target object. In particular, first surface 610 of the first black target plate 602 is mounted to a visible surface of the target object. Visible surface in this context means a surface that can be visualized by a machine vision system configured to image the marker 600 when used in operation.

Generally, the mounting location of the marker 600 is critical to the correct operation of the system as the pose measured is the pose of the marker 600, not the object upon which the marker 600 is mounted. However, in cases where the objective is to grasp or operate on the object (not the marker 600), the transform from the target reference frame to the object reference frame should be accurately determined and known. In an embodiment, the marker 600 includes two dowel pins and asymmetric mounting ‘ears’ (visible in marker 800 of FIG. 8, marker 1502 of FIG. 15A, 15B) to ensure the marker 600 is mounted accurately and in the correct orientation. Two dowel pins alone are symmetric with 180 degree roll; the asymmetric bolt ‘ears’ do not allow 180 degree error in mounting.

Referring now to FIG. 8, shown therein is a marker 800 in assembled form which is substantially similar to marker 600 and which has been assembled according to the method 700 of FIG. 7, according to an embodiment. Marker 800 is substantially similar to marker 600 of FIG. 6 and thus the same reference numerals for similar components are used.

Marker 800 also includes washers 802 and 804. The two washers 802, 804 are used with lubrication between them. The reason for this is that while in space, the black material of the marker 800 may absorb more heat energy from the sun than the object that the marker 800 is mounted on. The object the marker 800 is mounted on may be wrapped in reflective foil to keep the rays of the sun from overheating the object, while the marker 800 is not wrapped in this material to keep the marker completely exposed (for visualization). The thermal difference between the marker 800 and the object below the marker 800 (to which marker 800 is mounted) may cause thermal expansion differences. The use of these two washers 802, 804 with lubrication between them can allow the marker 800 to ‘slip’ as the marker 800 expands to avoid putting compression stress on the marker 800 that could deform or even break the marker 800 if or when there are significant thermal differences between the marker 800 and the object to which the marker 800 is mounted. Further, these two washers 802, 804 with lubrication between them reduce the likelihood of fastener damage due to thermal stress.

In variations of the markers 600, 800, or any marker of the present disclosure including an out of plane white dot, the post may have “positive length” or “negative length”. A positive length post, such as post 648, may include any structure that raises the out of plane white dot (e.g. white disc 648) above the plane of the square encoding stripe (e.g. above the plane of target pattern plate 606). In some embodiments, the positive length post may have a truncated cone shape, with the wider end of the truncated cone mounted to the marker and the white disc 648 mounted to the narrower end. In contrast, a negative length post may include any structure that lowers the out of plane white dot below the plane of the square encoding stripe. For example, the negative length post may take the form of a recess in the visualized side of the marker. The out of plane white dot (e.g. disc 648) is disposed on the bottom surface of the recess, such that the white dot is below the plane of the square encoding stripe. FIGS. 15A and 15B illustrate two perspective views 1500a, 1500b, respectively, of a marker 1502 having a “post with negative length”, according to an embodiment. Markers with positive length posts and negative length posts may be designed geometrically and algorithmically using the same specification, and may be treated identically by the vision system software.

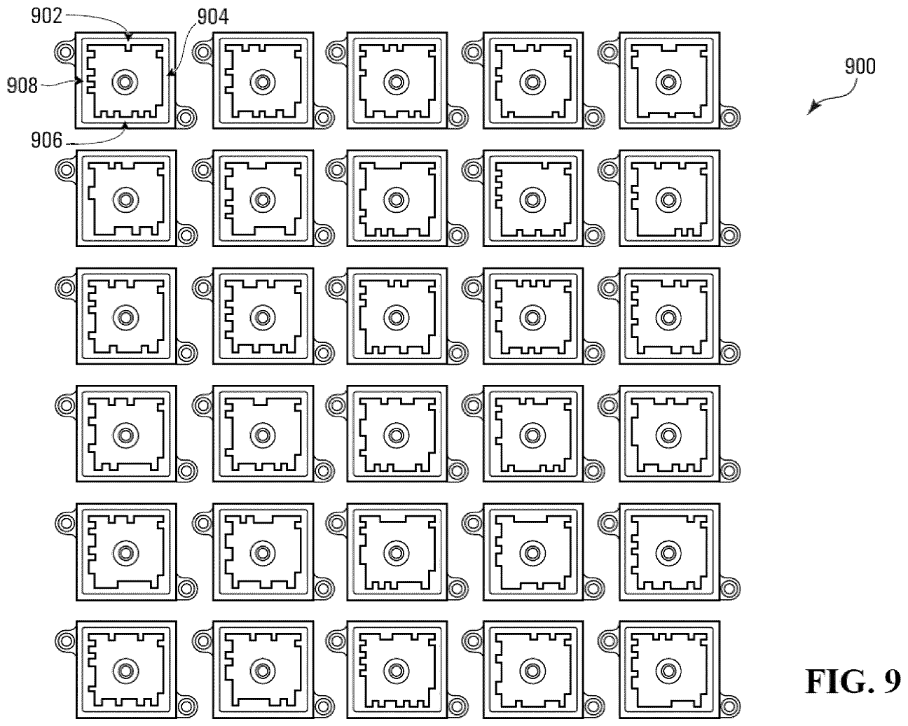

Referring now to FIG. 9, shown therein are a plurality of machine vision markers 900, according to an embodiment. Each of markers 900 is an example of machine vision marker 800 of FIG. 8.

Each of the plurality of markers 900 has a different (i.e. unique) data bit sequence that has been encoded in the square encoding stripe 104 of the respective marker. This has been achieved by each marker differing only in the composition of the black target pattern plate 606, and in particular the composition of the outer target pattern portion 638 of the black target pattern plate 606. Accordingly, each marker can be used for a different target object (or class of target object), with the respective data bit sequence linked to the target object identity in the machine vision system.

The black target pattern plate 606 of each of the markers 900 also includes predetermined corner values for enabling marker orientation determination. The predetermined corner values are constant across all of the markers 900.

In this particular embodiment, the predetermined corner values include a top left corner value of 0 (black square), a top right corner value of 0 (black square), a bottom left corner value of 1 (white square), and a bottom right value of 1 (white square). The top left corner has a top side adjacent value of 0 (black square) and a left side adjacent value of 0 (white square). The top right corner has a top side adjacent value of 0 (black square) and a right side adjacent value of 1 (white square). The bottom left corner has a left side adjacent value of 1 (white square) and a bottom side adjacent value of 1 (black square). The bottom right corner value has a right side adjacent value of 1 (white square) and a bottom side adjacent value of 0 (black square). Top side 902, right side 904, bottom side 906, and left side 908, to which the foregoing refers, are shown in FIG. 9. Thus, the term “bottom side adjacent value”, for example, refers to the square encoding element adjacent to the respective corner encoding element that is on the bottom side 906.

Accordingly, in this embodiment, the “predetermined corner value” for each corner includes the corner encoding element value as well as the two encoding element values adjacent the corner encoding element, as all three encoding element values are predetermined and constant for that corner across each of the markers 900 (i.e. 12 predetermined values, three for each of the four corners).

Referring now to FIG. 10, shown therein is a dual machine vision marker 1000, according to an embodiment.

Dual marker 1000 includes two markers 1002, 1004 of different sizes combined into a single marker 1000. Line 1006 in FIG. 8, which represents the outer edge of marker 1004 (in particular, of the second black target element 108 of marker 1004), is not actually present in the marker 1000.

Each of the markers 1002, 1004 is an example instance of marker 100 of FIG. 1. As such, features described above in reference to marker 100 may be referred to with the same reference numerals (but not shown in FIG. 10).

Smaller marker 1004 is mounted centrally on larger marker 1002.

The markers 1002, 1004 share an out of plane white dot 1010. The out of plane white dot 1010 is disposed at a generally central position on the dual marker 1000 on the smaller marker 1010.

Marker 1000 can be detected reliably and accurately over a longer range of distances than may be achievable with a single marker. For example, the large marker 1002 may be detected from a greater distance, while at closer ranges, when the large marker 1002 goes out of the field of view, the smaller marker 1004 is detected.

In an embodiment, image processing software may be used (e.g. executed by a processing device, such as processor 1114 of FIG. 11) that is configured to always search the images for all markers that could be present. If the marker is too small, the data bits cannot be resolved properly, and the marker cannot be identified. If part of the marker is outside the field of view, the marker cannot be identified. In other words, the entire marker must be inside the field of view of the camera for the marker to be identified. At far ranges the smaller inner marker 1002 will become too small to resolve before the larger outer marker 1004. At close ranges the larger marker 1004 will escape the camera field of view before the smaller inner marker 1002. At intermediate ranges, both markers 1002, 1004 are visible. Because both markers 1002, 1004 share the same reference frame, the pose from both markers 1002, 1004 is the same (ignoring pose measurement noise) so there is no conflict. The pose from both markers 1002, 1004 is available so higher level software can decide which pose to use, or fuse them together. The process is transparent and whenever a marker is available in the image the pose is calculated. As such calculation of the pose of the dual marker 1000 can be performed without further special programming.

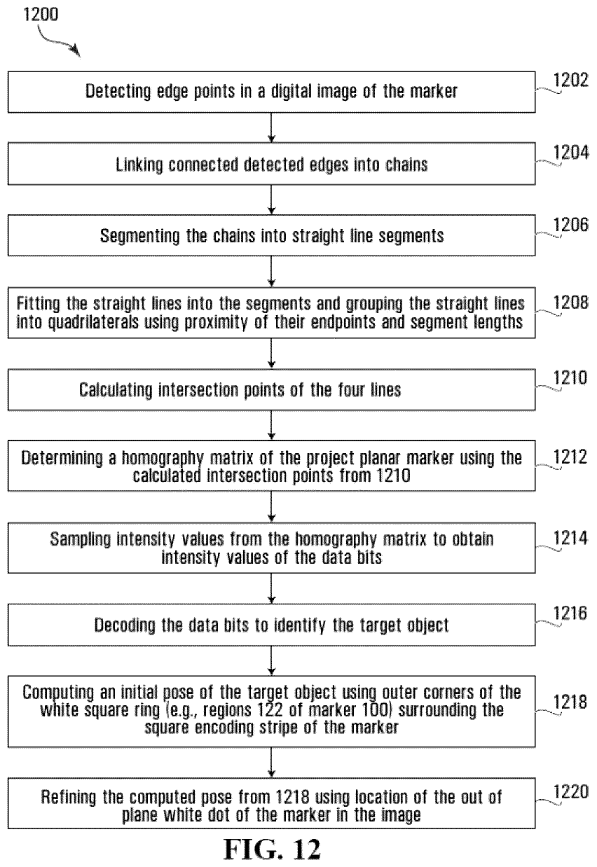

Reference will now be made to FIGS. 11 and 12, which illustrate systems and methods for detecting machine vision markers of the present disclosure, such as described above.

Referring first to FIG. 11, shown therein is a system 1100 for detecting, identifying, and pose determination of a machine vision marker, such as marker 100 of FIG. 1, according to an embodiment.

In a space-based application, the system 1100 can be used to determine a relative pose of an approaching spacecraft (e.g. target object 1104) during docking by processing images of the marker 100. Other applications may include, for example, identification and pose estimation for robotic tools, instruments, containers and replaceable units for orbital servicing and planetary exploration, and vision guided convoy driving.

The system 1100 includes a machine vision marker 1102 mounted to a target object 1104 and a machine vision system 1106 for acquiring and processing images of the marker 1102. The machine vision system 1106 may be disposed on a spacecraft or the like when used in space.

The target object 1104 may be any object for which identification and/or pose estimation may be desired. For example, in a space-based application, the target object 1104 may be a spacecraft, such as a satellite, which may be subject of a capture and docking process. The target object 1104 may be a robotic tool or instrument. The target object 1104 may be a container or replaceable unit, such as for orbital servicing and planetary exploration. The target object 1104 may be a vehicle that is part of a vision guided convoy mission.

The machine vision system 1106 includes a camera subsystem 1108 for capturing 1110 one or more digital images of the marker 1102. The machine vision subsystem 1106 includes at least one imaging device (e.g. camera), a light source for illuminating the marker 1102, and image processing software for generating and outputting digital images.

In some cases, the camera subsystem 1108 includes a monochromatic light source (e.g. LED light) located close to the camera and the camera includes a band pass filter that transmits the source light and attenuates any other illumination.

The machine vision system 1106 also includes a computer system 1112. In operation, the computer system 1112 is communicatively connected to the camera subsystem 1108 such that the computer system 1112 can instruct, via processor 1114, the camera subsystem 1108 to capture 1110 images of the marker 1102 and receive digital images from the camera subsystem 1108.

The processor 1114 of the computer system 1112 is configured to detect, identify, and determine a pose of the marker 1102 using digital images of the marker 1102 captured by the camera subsystem 1108. In some embodiments, the processor 1114 may include machine learning or machine intelligence software components (programs, modules, models, etc.) for the performance of computing tasks, such as the foregoing, using machine learning or machine intelligence techniques.

The computer system 1112 also includes a reference database 1116. The reference database 1116 may be stored in a memory or other data storage component of the computer system 1112. The reference database 1116 stores a plurality of data bit sequences for identifying a target object. For example, each reference data bit sequence may be unique and linked in the database to an identifier. The identifier may identify the target object 1104 as a member of a target object class (i.e. what kind of object is the target object) and/or as a specific instance of a target object class.

In operation, the camera subsystem 1108 is commanded by the processor 1114 to capture 1110 images of the marker 1102 on the target object 1104.

The digital images of the marker 1102 are outputted from the camera subsystem 1108 to the computer system 1112 for processing.

The processor 1114 is configured to first detect the marker 1102 in the digital image.

Once the marker 1102 is detected in the image, the processor 1114 is further configured to use image processing techniques to detect the square encoding stripe 104 of the marker 1102.

Using the detected square encoding stripe 104, the processor 1114 decodes a data bit sequence from the square encoding elements 114 in the square encoding stripe 104. This may include, for example, identifying a starting point (i.e. a first square encoding element) in the detected square encoding stripe 104 and proceeding in a predetermined order to determine a bit value for each square encoding element 114 in the square encoding stripe 104. This may include, for example, determining whether a square encoding element 114 is black or white and assigning a value of 0 or 1, respectively, to the data bit in the data bit sequence. The processor 1114 may determine whether the square encoding element is black or white by determining an intensity value for the square encoding element 114, for example by sampling. Intensity sampling may be performed by any suitable intensity sampling algorithm or technique.

The process of decoding the data bit sequence performed by the processor 1114 may include the processor 1114 first determining an orientation of the marker 1102. Determining the marker orientation enables the proper data bit sequence to be decoded. For example, the determined orientation of the marker 1100 can be used by the processor 1114 to identify a first encoding element 114 in the square encoding stripe and thus a first data bit in the data bit sequence.

In an embodiment, the processor 1114 determines an orientation of the marker 1100 and identifies the first encoding element 114 in the data bit sequence using predetermined corner values, as described herein. The predetermined corner values may be stored in the reference database 1116. The processor 1114 is configured to determine a correct orientation of the square encoding stripe 104 using the predetermined corner values. Identification and determined of predetermined corner values may be performed using any suitable computer vision or image processing algorithm or technique.

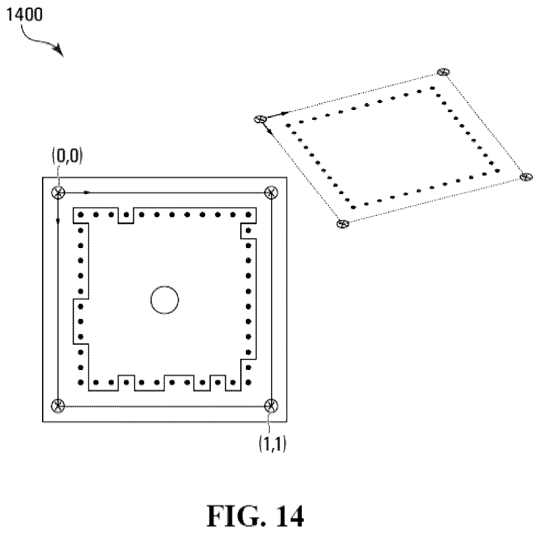

In an embodiment, image processing software executed by the processor 1114 starts by finding white squares in the image. When a white square is found, the software uses the corners of the image and a technique called homography to determine where in the image the software should look for the data bits. The data bit locations are with respect to the corners of the found white square. FIG. 14 shows an example marker 1400 illustrating where the sampling points are defined on the marker 1400 with respect to the corners of the white square ring. As the marker 1400 is projected into the image, the homography can be used to determine where in the image to sample the pixel intensity to determine if there is a 1 or a 0 at those locations. The four data bits on each corner may be used to encode the numbers from 0 to 3, one value on each corner, with a redundant data encoding so that one bit flip can be tolerated on each corner and still obtain the correct corner label. Once it is determined which corner is 0, which is 1, which is 2 and which is 3, it can be determined and known which side of the marker 1400 is ‘up’.

Once the data bit sequence has been determined by the processor 1114, the processor 1114 is configured query the reference database 1116 using the determined bit sequence and determine whether the determined bit sequence is a match for a reference data bit sequence. If the determined data bit sequence matches a reference data bit sequence, the processor 1114 assigns the identifier (or other such data linked to the reference data bit sequence) to the target object 1104. This assigned identity determined by the processor 1114 may then be used in subsequent processing by the computer system 1112 or by another computer system. If the determined data bit sequence does not match a reference data bit sequence in the reference database 1116, the processor 1114 may be configured to reject the target object 1104 as a non-target blob.

In some embodiments, the processor 1114 may be configured to determine a marker 1102 orientation using the predetermined corner values to resolve the roll ambiguity of the square marker 1102. The reference database 116 may store a marker identifier (marker ID) for each unique marker, where the marker identifier is retrievable or determinable from the data bit sequence (or a subset thereof). For example, the processor 1114 may be configured to look up the marker ID in a database using the data bit sequence or a subset thereof (e.g. a subset of the redundant data bits in the data bit sequence, such as ‘middle’ data bits). The marker identifier is linked in the database to marker dimension data such that the marker dimension data can be retrieved from the database using the marker identifier. The marker dimension data includes physical dimension information about the marker. Once the marker orientation and marker dimensions are determined by the processor 1114, the vertices of the square of the marker and the peg tip image coordinates photogrammetrically define the pose (x, y, z, pitch, yaw, roll) of the target frame of reference.

The processor 1114 may also determine a pose of the marker 1102 in the image. This may include, for example, applying image processing techniques to identify pose calculation features (i.e. regions 122a, 122b, 122c, 122d) in the marker image and determine a pose estimation of the marker 1102 using the pose calculation features. Pose estimation using the pose calculation features may be performed using any suitable pose estimation algorithm or technique.

In an embodiment, the locations of the four corners of the white square ring (regions 122) of the marker 1102 in the image are determined (in 2D). The marker identifier may be determined using the decoded data bit sequence and the marker dimension data determined from the database using the marker identifier to determine the marker dimensions. Then, the system knows the four corners of the white square ring of the marker (in 3D). The system stores and can reference camera property data describing properties of the camera used to capture the image of the marker such as image center, lens warping parameters, local length, etc. A ‘Perspective-N-Point’ algorithm is the used to match the 2D corner points to the 3D corner points to determine the position and orientation of the marker in the camera frame.

In an embodiment, pose determination includes detecting corners of the white square ring (regions 122) in the image data of the marker using a region based detector such as a maximally stable external regions (“MSER”) detector configured to find the pixels that belong to bright regions surrounded by dark regions. The contour is then broken down into a quadrilateral. The sub-pixel equations of the four lines of the quadrilateral are then determined. Then, the four line equations are intersected to find the sub-pixel corners of the white square.

In embodiments of the marker 100 including an out of plane white dot 110, the foregoing pose estimation may be an initial pose determination and the processor 1114 may be further configured to refine the initial pose estimation using the out of plane white dot 110. Pose estimation using the out of plane white dot 110 may be performed using any suitable pose estimation algorithm or technique.

The pose estimation may use information on the camera calibration and size of the marker.

In some cases, the processor 1114 may be configured to compute an overall pose of the target object using multiple markers 1102 on the target object 1104 having known relative locations and determining a pose for each marker using the processor 1114. This may provide a pose estimation having improved accuracy.

In some embodiments, the machine vision system 1106 may not require any initialization and may use marker models (encoded identity and dimensions) and camera calibration data (relating to camera subsystem 1108) stored in a file system on computer system 1112. Processing time may depend on factors such as the image resolution, complexity of the scene, and computing platform.

Reliable detection and identification of the marker 1102 by the machine vision system 1106 may require that the marker 1102 is fully visible in the camera field of view, occupy a minimum number of pixels in images (e.g. at least 30×30 pixels in images), and is within a specified range of orientations. The actual maximum distance may be a function of the size of the marker 1102, camera field of view, and image resolution. The minimum distance may correspond to the case when the marker 1102 fills up the camera field of view. The allowed range of marker orientations may depend on the height of the post (in embodiments where the post is present). The pose estimation accuracy of the computer system 1112 may depend on the size of the marker 1102, post height, camera resolution and field of view, and the distance.

In an embodiment, the processor 1114 operates on each image separately without relying on results of processing previous images (i.e. no inter frame tracking is performed). This my require additional computation but can ensure that the machine vision system 1106 recovers instantly (for the next image) from data loss due to, for example, occlusion.

Referring now to FIG. 1200, shown therein is a method 1200 of detecting, identifying, and determining a pose of a machine vision marker, such as marker 100 of FIG. 1, according to an embodiment.

The method 1200 may be encoded in computer-executable instructions for execution by a processor, such as processor 1114 of FIG. 11. The method 1200 may be performed by processor 1114 of FIG. 11.

The method 1200 may be performed on a digital image of the marker 1102 captured by the camera subsystem 1108 of FIG. 11.

At 1202, the method 1200 includes detecting edge points.

The edge points are pixels which have an abrupt change in intensity to their neighboring pixels. The edge points are used to identify the location on the image between the inner white square ring and the outer black square ring. The edge points may be detected using an operator like the Sobel kernel, wherein the Sobel kernel or operator transforms an image to emphasize edges, typically for edge detection algorithms, such as those applied herein.

In another embodiment, a region-based target extraction algorithm may be used that is based on identifying regions and does not rely on edge pixels.

At 1204, the method 1200 includes linking connected detected edges into chains.

Linking edge pixels into chains includes finding edge pixels that are adjacent or near each other that have similar orientation with the goal of creating a chain of edge pixels that can be broken into lines of edge pixels.

At 1206, the method 1200 includes segmenting the chains into straight line segments.

At 1208, the method 1200 includes fitting the straight lines into the segments and grouping the straight lines into quadrilaterals using proximity of their endpoints and segment lengths.

At 1210, the method 1200 includes calculating intersection points of the four lines of the quadrilateral from 1208.

At 1212, the method 1200 includes determining a homography matrix of the projected planar marker using the calculated intersection points from 1210.

At 1214, the method 1200 includes sampling intensity values from the homography matrix to obtain intensity values of the data bits.

At 1216, the method 1200 includes decoding the data bits to identify the target object 1104 (i.e. the decoded data bit sequence matches a reference data bit sequence in reference database 1116) or reject the quadrilateral if the data bit sequence does not match a reference data bit sequence (e.g. stored in reference database 1116).

This may include, for example, assigning a 1 or a 0 to a given data bit in the sequence based on the intensity values determined at 1214, and then querying a reference database (e.g. database 1116) of reference data bit sequences to see if the determined data bit sequence matches a reference data bit sequence. Each reference data bit sequence is linked in the database to identification information, such as a unique identifier, specifying a target object identity. As such, when the reference database is queried with the determined data bit sequence having a matching reference bit sequence, the reference data bit sequence returns the linked identifier specifying an identity of the target object.

At 1218, the method 1200 includes computing an initial pose of the target object using four corners of the square (regions 122 of marker 100). In particular, the four corners used are the outer corners of the white square ring of the white target element (e.g. white target element 106 of marker 100) that surrounds the square encoding stripe (e.g. square encoding stripe 104 of marker 100).

As previous described herein, the four corner points are known in 3D by virtue of having determined the marker ID and the marker dimensions using the marker ID and the 2D image points that those corner points project to are known, having also been determined. A ‘Perspective-N-Point’ algorithm can then be used to determine the marker pose even from only the corner points (knowing the camera properties (image center, focal length, etc.)). Camera properties may be identified via internal calibration to determine focal length, image center, optical distortion profiles, etc. Once this four point pose is determined, the location of the post (i.e. where the post should be) on the image can be predicted. Then, from that initial guess on where the post should be in the image, the exact position of the post can be determined from the data in the image. Then, a full five point pose is computed (e.g. using a similar ‘perspective-N-point’ algorithm).

At 1220, the method 1200 includes refining the computed pose using location of the out of plane white dot 110.

This may include using the pose calculated at 1218 and marker dimension information (retrieved from database using determined marker ID) to estimate where the out of plane white dot 110 (e.g. post or recessed dot) should be on the image. Then, the software looks for the dot 110 at that point in the image. Once the image location of all five pose calculation features has been determined (the four corners of the inner white square ring 106 of the marker on the image, and the center of the white dot 110) in 2D and 3D and the camera parameters are known (stored in and retrievable by the computer system), a ‘Perspective-N-Point’ algorithm to calculate the refined pose. It should be noted that the center of an ellipse created by the projection of a disc is different than the projected center of the disc and that the computer system can be configured to correct for this.

In some cases, the four corner points may be used to obtain the pose without refining using an out of plane white dot (non-planar feature), such as in planar embodiments of the marker of the present disclosure.

In some cases, the pose computations performed at 1218, 1220 may be performed only if, at 1216, the determined data bit sequence matches a reference data bit sequence in the reference database 1116 (i.e. only if the marker is not rejected as a non-target blob).

The machine vision markers, methods for assembling a machine vision marker, and systems and methods for identifying and determining pose of a target object using a machine vision marker of the present disclosure may provide certain advantages.

The machine vision marker of the present disclosure includes distinctive and precisely placed target features which can facilitate unambiguous and reliable detection, and accurate estimation of relative position and orientation (pose).

The markers are reliably detected under a wide range of viewing distances and angles, and illumination (including direct sun light and shadows). Encoded redundant features allow identification even with a partial data loss. Embodiments of the marker having a three dimensional structure (e.g. out of plane white dot 110 of marker 100) may improve accuracy of pose estimation.

Detection algorithms for detecting the machine vision marker, such as may be executed by processor 1114 of FIG. 11, may be configured to operate on each image separately and in real time, which does not require tracking between frames and may allow instant recovery from failures due to, for example, marker occlusions.

Referring now to FIG. 13, shown therein is a machine vision marker 1300, according to an embodiment. The machine vision marker 1300 may be the machine vision marker 100 of FIG. 1.

Marker 1300 includes predetermined corner values (or ‘corner’ data bits) in the square encoding stripe, as described herein. The ‘corner’ data bits are OT1-OT4, OR0-OR4, OB0-OB4, OL0-OL4. These corner data bits are used to solve the target roll ambiguity (i.e. which way is ‘up’). The corner data bits achieve this by encoding 0, 1, 2, 3 each on one of the corners, encoded in a four bit message, allowing one bit flip per corner and still getting the correct answer. Once it is determined which way is up for the marker 1300 using the predetermined corner values, the marker ID can be determined from the ‘middle’ data bits D0-D27 (‘middle’ data bits being those data bits, or encoding elements, between the ‘corner’ data bits which are consistent across all instances of the marker). The ‘middle’ data bits are shown as grey in FIG. 13, indicating that each bit may be black or white depending on the particular data bit sequence encoded in the marker 1300. A predetermined starting point for decoding the D0-D27 data bits is then identified and the D0-D27 data bits are decoded. In an embodiment, the starting point for decoding the D0-D27 data bits if Ot0/OL4 and the data bits are read clockwise around the square encoding stripe.

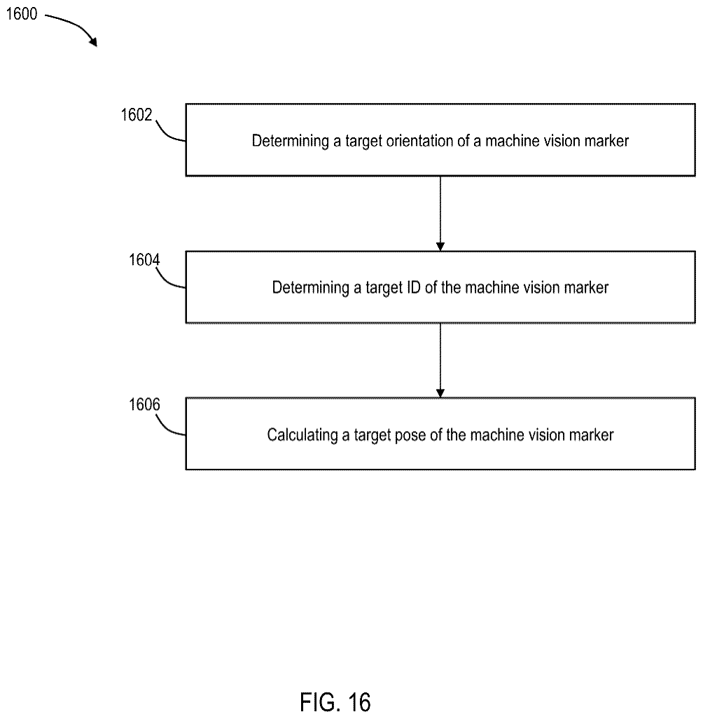

Referring now to FIG. 16, shown therein is a method 1600 of calculating a pose of a machine vision marker, according to an embodiment. The machine vision marker may be, for example, any of marker 100 of FIG. 1, marker 600 of FIG. 6, marker 800 of FIG. 8, marker 1102 of FIG. 11, or marker 1502 of FIGS. 15A-B.

The method 1600 may be executed by the computer system 1112 of FIG. 11. The method 1600 may be embodied as computer-executable instructions stored in memory and which, when executed by a processor such as processor 1114 of FIG. 11, cause the computer system 1112 to perform the method 1600.

At 1602, the method 1600 includes determining a target orientation of the machine vision marker. An image including the machine vision marker is captured. The image may be preprocessed (e.g., as outlined later in method 1700). The machine vision marker orientation may be determined by sampling corner data bits of the machine vision marker, as described previously in reference to FIG. 13. For example, the corner bits comprise a known pattern, wherein depending on the value of the corner bits of the machine vision marker within the image, only a unique orientation may be determined. As described in reference to 1602, orientation refers to the identification of one of the square edges of the machine vision marker (e.g., the top edge of the square marker in the image is determined to be the “bottom edge” of the marker, such that the marker is upside down).

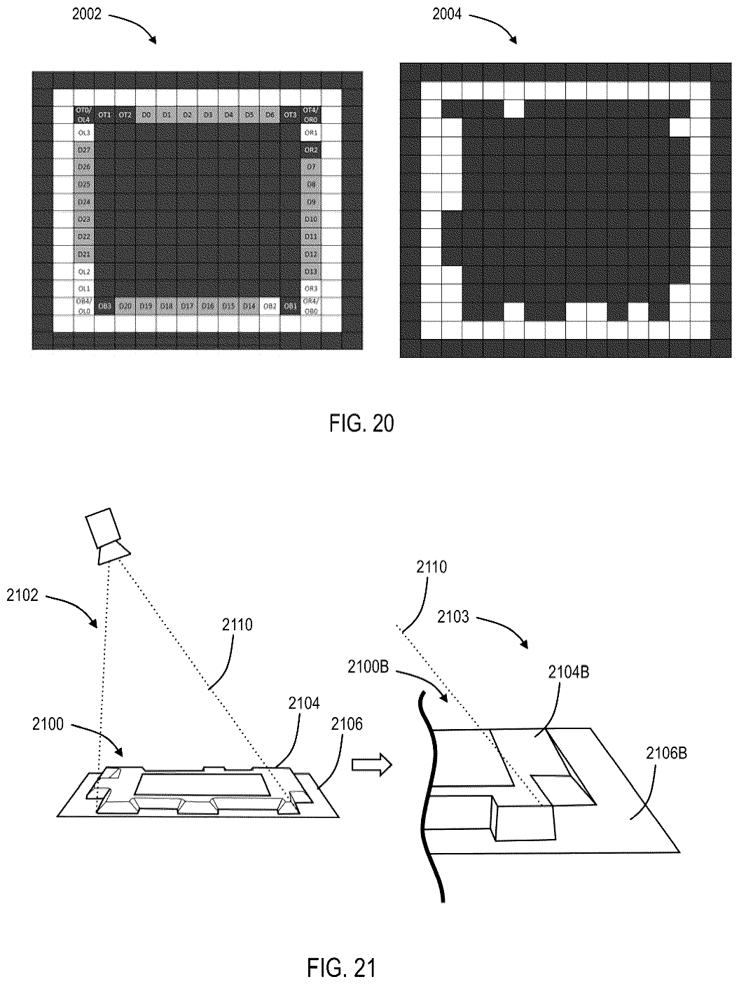

At 1604, the method 1600 includes determining a target ID of the machine vision marker. The remaining data bits (e.g., data bits excluding the corner bits sampled to determine orientation at 1602), or some subset thereof, may be sampled to read the data encoded by the data bits of the marker. Sampling locations may be determined according to the target orientation determined at 1602. For example, see FIG. 20, showing a depiction 1902 of a target marker with data sampling locations highlighted (see locations D0-D27), and a depiction 1904 of the same target marker wherein sampling locations are not highlighted.

In some examples, locations D0-D27 (as seen in FIG. 20), comprising 28 bits, may be sampled, to determine a 13-bit message. In such examples, each message is separated by at least 7 bits, allowing for error corrections of up to 3 bit flips.

In other examples, other numbers of data bits may be apportioned for target ID encoding and determination, and messages may comprise other numbers of bits.

In some examples, the message encoded by the data bits may comprise a target ID value. When the message encoded by the data bits is determined, a corresponding target ID is determined.

In some examples, the target ID may be referenced against a target database as described previously. In examples wherein the determined target ID is not present in the database, method 1600 may cease, as it may be deemed that the image which is being processed by method 1600 does not include a valid machine vision marker.

In some examples, the target ID may be any one or more of a marker ID, target object ID, and/or interface type ID. Accordingly, the target ID, when determined, may provide information about the marker (e.g., size, dimensions), the target object (e.g., what type of object the marker is attached to), or the robotic interface of which the target object is a component. For example, knowing what type of object or robotic interface may enable identification (e.g., autonomously) of a robotic tool for use on the target object, based on the target ID.

At 1606, the method 1600 includes calculating a target pose of the machine vision marker. The positioning of the machine vision marker may be determined. For example, the location and/or coordinates of the corners 122 of marker 100 may be determined. These coordinates, along with camera data associated with the camera used to capture the image of the machine vision marker may be applied to calculate the target pose. Any suitable pose calculation method or algorithm may be applied to calculate the target pose at 1606. For example, a POSIT algorithm may be applied to calculate the target pose at 1606.

The ID determined at 1604 may be applied to determine the target pose of the machine vision marker. For example, a system or environment may comprise a plurality of markers. Markers may vary in absolute size. The size of each marker may be known to computer system 1112, by referencing the target ID of each marker with a marker size associated with the ID, stored in a database (e.g., database 1116). The marker size may be applied at 1606 to perform the target pose calculation (for example, using a POSIT algorithm, wherein a POSIT algorithm is a model-based iterative pose algorithm using scaling and orthographic projection).

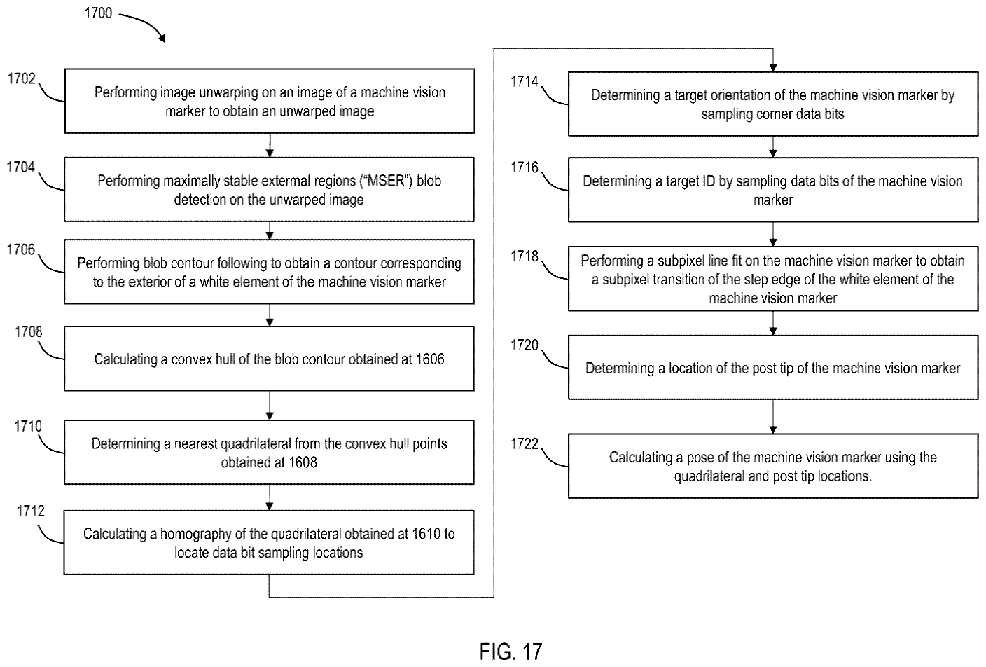

Referring now to FIG. 17, shown therein is a method 1700 of calculating a pose of a machine vision marker. The machine vision marker may be, for example, any of marker 100 of FIG. 1, marker 600 of FIG. 6, marker 800 of FIG. 8, marker 1102 of FIG. 11, or marker 1502 of FIGS. 15A-B.

The method 1700 may be executed by the computer system 1112 of FIG. 11. The method 1700 may be embodied as computer-executable instructions stored in memory and which, when executed by a processor such as processor 1114 of FIG. 11, cause the computer system 1112 to perform the method 1700.

At 1702, the method 1700 includes performing image unwarping on an image to obtain an unwarped image.

An image may be captured by the camera 1108 of FIG. 11 of a scene wherein one or more machine vision markers (e.g., marker 100) is present or is expected to be present. The image, as captured by camera 1108, may comprise warping or distortion associated with the camera 1108, such as barrel distortion, pincushion distortion, and/or other forms of known distortion. At 1702, unwarping is applied to the captured image to correct for this distortion. Unwarping 1702 may include the application of a distortion or warp correction map associated with camera 1108 to the captured image. Such a map may be generated using a calibration process specific to the camera 1108.

In one example, unwarping may include calculating the pixel intensity of the unwarped imaged by applying the sub-pixel mapping in the x and y directions using bilinear interpolation.

In other examples of method 1700, any image unwarping method or algorithm may be applied to the image to produce an unwarped image.

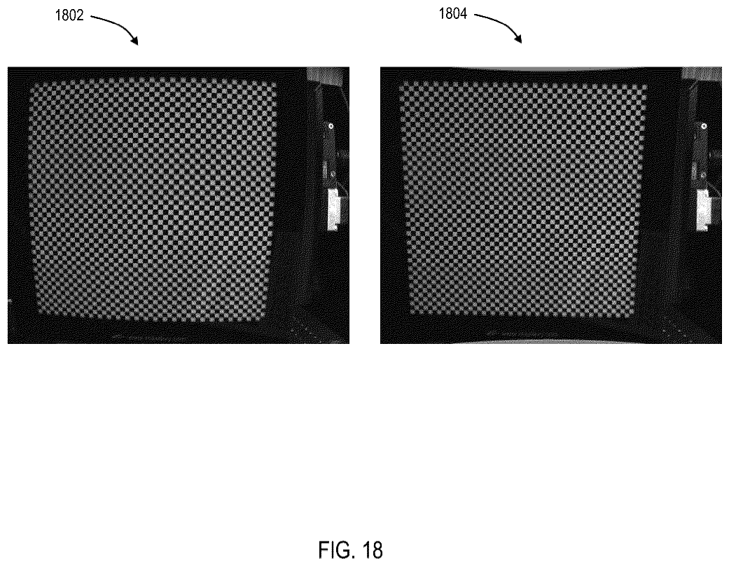

See FIG. 18, for an example of a raw, warped image 1802, and an unwarped image 1804, after the completion of step 1702. Unwarped image 1804 faithfully reproduces the straight lines of the grid displayed in the image 1804, versus the warped lines of warped image 1802 due to barrel distortion.

At 1704, the method 1700 includes performing maximally stable external regions (“MSER”) blob detection on the unwarped image.

MSER is performed to detect blobs or regions characterized by boundaries having sharp and/or transitions. Such regions are characteristic of the elements of the machine vision marker (e.g., marker 100), such as white target element 106.

In some examples of method 1700, other suitable image processing methods may be applied to detect the region or blob associated with white target element 106.

At 1706, blob contour following is performed to obtain a contour corresponding to the exterior of a square ring (e.g. exterior edges of white target element 106 of machine vision marker 100). The contour following method performed at 1706 may comprise a vertex-following algorithm.

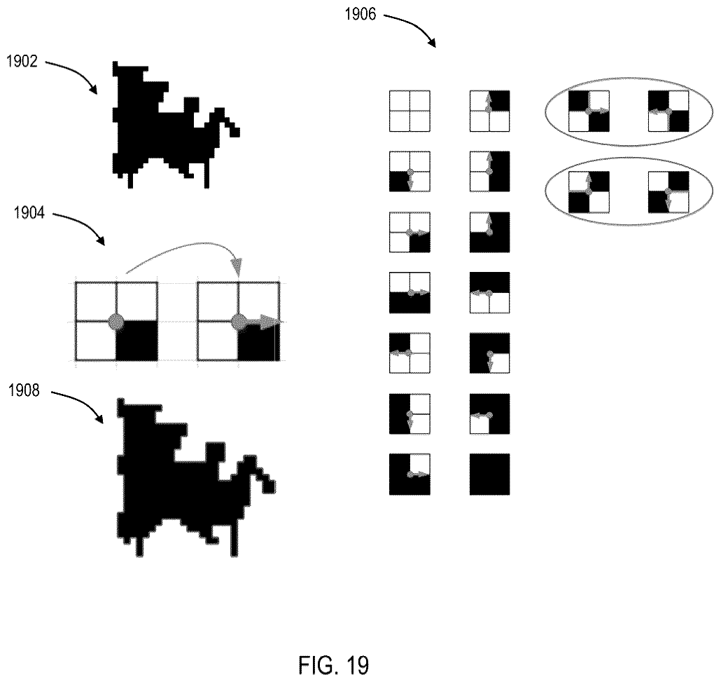

For example, see FIG. 19, wherein a vertex-following algorithm is illustrated further. A contour may be drawn around a blob 1902. Starting at the upper most left pixel of the blob 1902, a first step may be traced, as illustrated at 1904. Subsequently, steps may be followed as per the pattern outlined in table 1906, until the contour intersects the original upper left most starting pixel, completing the contour, resulting in contour 1908.

In other examples of method 1700, other contour following algorithms may be applied at 1706 to obtain a contour corresponding to the exterior of a square ring (e.g., exterior edges of white element 106 of machine vision marker 100). For example, a pixel-following type algorithm may be applied, or any other suitable contour following may be applied to obtain a contour corresponding to the exterior edges of white element 106 of machine vision marker 100.

At 1708, the method 1700 includes calculating a convex hull of the blob contour obtained at 1706.

The contour obtained at 1706 may comprise a plurality of points or coordinates. A convex hull may be calculated, for example, using the quickhull algorithm. In other examples, other algorithms may be applied to calculate the convex hull.

After the completion of 1708, a plurality of convex hull points or coordinates are obtained, which may be used for further processing.

At 1710, the method 1700 includes determining a nearest quadrilateral from the convex hull points obtained at 1708.

In some examples, an algorithm to determine the nearest quadrilateral from the convex hull points may be applied wherein a single point per iteration is removed. A point is removed by combining two consecutive points into a single point. The points selected are chosen as the pair that, when combined to a single point, add the least amount of area to the overall contour. This process may be repeated until only four points remain, defining a quadrilateral. The quadrilateral is generally aligned with the white element 106 of the machine vision target, such that the vertices defining the quadrilateral are generally aligned with corners 122.

In some examples, other algorithms may be applied to determine a nearest quadrilateral from the convex hull points obtained at 1708.

At 1712, the method 1700 includes calculating a homography of the quadrilateral obtained at 1710 to locate data bit sampling locations.

The data bit sampling locations may be defined in a coordinate system (u,v) where the origin is the upper left corner of the white element 106 and the lower right corner of the white element 106 is coordinate (1,1). The data bit sampling locations may be addressed relative to these coordinates. For example, see FIG. 14, wherein a coordinate system is illustrated, and sampling locations are visible.

Calculating the homography at 1712 allows for the correct data bit sampling locations to be located when the marker is skewed or unaligned relative to the plane of the camera sensor. The homography may correct for this skew or misalignment.

At 1714, the method 1700 includes determining a target orientation of the machine vision marker by sampling corner data bits.

The machine vision marker target orientation may be determined by sampling corner data bits of the machine vision marker, as described previously in reference to FIG. 13, to solve 4 symmetry roll ambiguity of the marker. For example, the corner bit locations are known, as determined at 1712. The value of the corner bits may be sampled, wherein depending on the value of the corner bits of the machine vision marker within the image, a unique orientation of the marker may be determined. As described previously, orientation refers to the identification of one of the square edges of the machine vision marker as a certain square edge. For example, the top edge of the square marker in the image is determined to be the true “bottom edge” of the marker, such that the marker is upside down. Such a determination may be used to determine the orientation of the target for the sampling of the remaining data bits (e.g., at 1716).

The corner bits of the machine vision marker may be arranged in a human readable arrangement, wherein the corner bits may be readily interpreted by visual inspection by a human operator.

The corner bits may comprise two bits of information encoded into a four bit message. In some examples, the corner bits may comprise a hamming distance of at least 3 between corner patterns associated with each of the four orientations, such that an error of 1 bit may be corrected.

At 1716, the method 1700 includes determining a target ID by sampling data bits of the machine vision marker.

The remaining data bits (e.g., data bits excluding the corner bits sampled to determine orientation at 1714) may be sampled to read the data encoded by the data bits of the marker. Sampling locations may be determined according to the locations determined at 1712, and the target orientation determined at 1714. For example, see FIG. 20, showing a depiction 2002 of a target with data sampling locations highlighted (see locations D0-D27), and a depiction 2004 of the same target wherein sampling locations are not highlighted.

In some examples, locations D0-D27 (as seen in FIG. 20), comprising 28 bits, may be sampled, to determine a 13-bit message. In such examples, each message is separated by at least 7 bits, allowing for error corrections of up to 3 bit flips.

In other examples, other numbers of data bits may be apportioned for target ID encoding and determination, and messages may comprise other numbers of bits.

In some examples, the message encoded by the data bits may comprise a target ID value. When the message encoded by the data bits is determined, a corresponding target ID is determined.

In some examples, the target ID may be referenced against a target database as described previously. In examples wherein the determined target ID is not present in the database, method 1700 may cease, as it may be deemed that the image which is being processed by method 1700 does not include a valid machine vision marker.

It may be advantageous to conduct target ID determination before calculating target pose (i.e. as calculated at 1722), as calculating a target pose may be of no benefit if no known machine vision marker is detected. Skipping such operations in examples wherein no machine vision marker is detected may reduce processing power requirements of a system performing method 1700.

At 1718, the method 1700 includes performing a subpixel line fit on the machine vision marker to obtain a subpixel transition of the step edge (e.g. of the white element 106) of the machine vision marker.

In some examples, performing a subpixel line fit may comprise the application of an optimization method to obtain the subpixel transition of the step edge of the white element of the machine vision marker.

By performing the subpixel line fit at 1718, the position of the external boundary of the white element (e.g., 106) of the marker may be more precisely located. By precisely locating this boundary, a more precise pose calculation may be later computed by method 1700. After the completion of 1718, the location of the four points of the quadrilateral may be refined and/or updated to correspond to the more precise boundary located at 1718 through the subpixel line fine operation.

In some examples of method 1700, the subpixel line fit may be performed before 1712, 1714 and/or 1716. It may be advantageous to perform 1718 after 1716, as if no target ID matching a known target ID is detected, no machine vision target may be present. Performing a subpixel line fit may be a waste of processing resources if such an operation is performed on an image wherein no machine vision target is present.

In some examples of method 1700, the subpixel line fit may be performed after 1720.

At 1720, the method 1700 includes determining a location of the post tip or out of plane white dot of the machine vision marker.

Based on the location and/or position of the four corners of the quadrilateral detected at 1710 (or refined at 1718), an estimated pose of the marker may be determined. In some examples, the estimated pose may be determined using infinitesimal plane-based pose estimation, or another suitable pose estimation algorithm.

Once the estimated post is determined, the approximate location of the post tip may be determined and/or known. The area surrounding the approximate location of the post tip may be thresholded to find the centroid of the post tip visible in the image, which may comprise an ellipse. After the centroid of the post tip is located, the located centroid position may be corrected to account for the projection error associated with the out of plane post tip. As previously described, the center of an ellipse created by the projection of a disc is not the projected center of the disc. Such a correction may apply the out of plane distance or dimension of the post tip, which may be known (for example, by referencing the target ID which was previously determined).

At 1722, the method 1700 includes calculating a pose of the machine vision marker using the quadrilateral points and post tip location.

The pose of the machine vision marker may be calculated using a POSIT algorithm, or any other suitable algorithm. These coordinates, along with camera data associated with the camera used to capture the image of the machine vision marker may be applied to calculate the target pose. Any suitable pose calculation method or algorithm may be applied to calculate the target pose at 1722. For example, a POSIT algorithm may be applied to calculate the target pose at 1722.

The ID determined at 1716 may be applied to determine the target pose of the machine vision marker. For example, a system or environment may comprise a plurality of markers. Markers may vary in absolute size. The size of each marker may be known to computer system 1112, by referencing the target ID of each marker with a marker size associated with the ID, stored in a database (e.g. database 1116). The marker size may be applied at 1722 to perform the target pose calculation (for example, using a POSIT algorithm).

After the completion of 1722, the target pose is known, along with the target ID. Such information may be applied to a subsequent operation.

While the above description provides examples of one or more apparatus, methods, or systems, it will be appreciated that other apparatus, methods, or systems may be within the scope of the claims as interpreted by one of skill in the art.

1. A machine vision marker for use on a target object, the marker comprising:
a first black target element comprising a black square;
a square encoding stripe that extends around a perimeter of and encloses the black square, the square encoding stripe composed of a plurality of square encoding elements collectively encoding a binary data bit sequence encoding identification information about the target object, wherein each respective one of the plurality of square encoding elements is either a black square or a white square representing a data bit of 0 or 1 in the binary data bit sequence, respectively;
a white target element comprising a white square ring that extends around a perimeter of the square encoding stripe and encloses the square encoding stripe;
a second black target element comprising a black square ring that extends around a perimeter of the white square ring of the white target element; and
an out of plane white dot post disposed above or below a plane of the marker and positioned centrally on the marker.

2. (canceled)

3. The marker of claim 1, further comprising a black post for raising the out of plane white dot above the plane of the marker, the black post having a base at a first end for mounting the black post to at least one of the target elements and a post tip at a second end opposing the first end on which the out of plane dot is disposed.

4. The marker of claim 2, wherein the post tip includes a black ring around the out of plane white dot.

5. The marker of claim 1, wherein each of the white target element, the white square encoding elements, and the out of plane white dot are composed of a retroreflective material.

6. The marker of claim 1, wherein:
the black square encoding elements are integrally formed with and arranged around the perimeter of the black square of the first black target element, forming a target pattern element;
the white target element is a white square, and the white square ring of the white target element forms an outer perimeter of the white square; and
the target pattern element is disposed centrally on the white target element such that the white square encoding elements of the square encoding stripe are formed from portions of the white square around the perimeter of the black square of the target pattern element that are not obscured by the black square encoding elements.

7. The marker of claim 1, further comprising a recess in a visualized side of the marker for lowering the out of plane white dot below the plane of the marker, and wherein the out of plane white dot is disposed in the recess.

8. The marker of claim 1, wherein the square encoding stripe includes a redundant encoding of the identification information of the target object which allows for correct decoding of the target object identity with up to three bit flips in the binary data bit sequence.

9. The marker of claim 1, wherein the square encoding stripe includes four corner square encoding elements, and wherein the data bit values of the four corner encoding elements are predetermined based on fixed corner square encoding element values that are used across all markers of which the marker is one instance.

10. The marker of claim 9, wherein the four corner square encoding elements include a top left encoding element, a top right encoding element, a bottom right encoding element, and a bottom left encoding element, and wherein either the top left and top right encoding elements are black squares and the bottom left and bottom right encoding elements are white squares or the top left and top right encoding elements are white squares and the bottom left and bottom right encoding elements are black squares.

11. (canceled)

12. The marker of claim 1, wherein the first black target element is at least 10 square encoding elements wide, and each of the square encoding stripe, the white square ring of the white target element, and the black square ring of the second black target element have a width equal to one square encoding element.

13-15. (canceled)

16. The target of claim 6, wherein the second black target element is a square piece of material having a square shaped recess dimensioned to receive the white target element therein and a non-recessed portion extending around the recess which forms the black square ring, and wherein the marker is assembled by mounting the white target element in the square shaped recess of the second black target element and mounting the first black target element on the white target element.

17. The target of claim 6, wherein the target pattern element comprises beveled edges.

18. A system comprising the marker of claim 1 and a machine vision subsystem, the machine vision subsystem comprising:
an imaging device for capturing image data of the target; and
a processing device configured to:
detect the square encoding stripe in the image data;
decode corner data bit values for each of four corner square encoding elements of the square encoding stripe;
determine an orientation of the marker in the image data using the corner data bit values by referencing predetermined corner values for the marker stored in memory;
decode the data bit sequence using the determined orientation; and
determine whether the decoded data bit sequence matches a reference data bit sequence stored in a reference database.

19. The system of claim 18, wherein the reference data bit sequence is linked in the reference database to target object identification data identifying an attribute of the target object, and wherein the processing device is further configured to use the linked target object identification data in a subsequent processing operation if the decoded data bit sequence matches the reference data bit sequence.

20. (canceled)

21. The system of claim 18, wherein the processing device is further configured to:
detect corners of the white square in the image data of the marker for use as pose calculation features; and
determine a pose of the target object using the pose calculation features.

22. The system of claim 21, wherein the processing device is further configured to refine the pose of the target object using the out of plane white dot.

23. (canceled)

24. A method of manufacturing a square machine vision marker having improved roll ambiguity properties for determining marker orientation in use, the method comprising:
manufacturing a plurality of square machine vision markers each having a square encoding stripe comprising a plurality of square encoding elements, each square encoding element being black or white, the square encoding stripe encoding a binary data bit sequence decodable by a machine vision system to obtain information about a target object on which the marker is displayed, wherein the plurality of square machine vision markers include at least a first machine vision marker having a first square encoding stripe and a second machine vision marker having a second square encoding stripe, the first and second square encoding stripes being different;
wherein the square encoding stripe of each of the plurality of square machine vision markers includes the same predetermined corner square encoding element values such that the corner square encoding element values are fixed and consistent across the plurality of square machine vision markers, the corner square encoding elements being configured such that two non-opposing corner encoding elements are black squares and two non-opposing white corner encoding elements are white squares.

25. (canceled)

26. A method of detecting a target pose of a machine vision marker, the method comprising:
determining a target orientation of the machine vision marker, wherein determining the target orientation comprises sampling corner data bits of the machine vision marker;
determining a target ID of the machine vision marker; and
calculating a target pose of the machine vision marker.

27-39. (canceled)

40. The method of claim 26, the method further comprising determining a location of a post tip of the machine vision marker.

41. The method of claim 26, wherein calculating the target pose of the machine vision marker comprises applying the quadrilateral a post tip location.

42. (canceled)
